(19) United States
(12) Patent Application Publication
(10) Pub. No.: US 2023/0048195 A1
(43) Pub. Date: Feb. 16, 2023

(54) NEAR-EYE DISPLAY DEVICE

(71) Applicant: KOREA INSTITUTE OF SCIENCE AND TECHNOLOGY, Seoul (KR)

(72) Inventor: Sung Kyu KIM, Seoul (KR)

(73) Assignee: KOREA INSTITUTE OF SCIENCE AND TECHNOLOGY, Seoul (KR)

(21) Appl. No.: 17/778,979

(22) PCT Filed: Mar. 22, 2021
(86) PCT No.: PCT/KR2021/003528

§ 371 Date: May 23, 2022

(30) Foreign Application Priority Data
Jul. 7, 2020 (KR) 10-2020-0083211
Jan. 18, 2021 (KR) 10-2021-0006699

(51) Int. Cl. G02B 30/25; G02B 27/01; G06F 3/01; G06F 1/16

(52) U.S. Cl. CPC G02B 30/25; G02B 27/0172; G02B 27/0179; G06F 3/013; G06F 1/163; G02B 2027/0123; G02B 2027/0187; G02B 2027/0127; G02B 27/283

(57) ABSTRACT

The present invention relates to a near-eye display device. The a near-eye display device includes a display, a first lens disposed in front of the display so as to be spaced apart from the display by a predetermined distance, a dynamic aperture adjustment element disposed adjacent to the first lens to dynamically control an aperture size of the first lens and a horizontal position of the aperture on a plane perpendicular to an optical axis, a main optics lens disposed to be spaced apart from the first lens by a predetermined distance, and a control system configured to control the dynamic aperture adjustment element.

### TECHNICAL FIELD

The present invention relates to a near-eye display device capable of implementing a multifocal view while dynamically providing a three-dimensional parallax image.

### BACKGROUND ART

Korean Patent Registration No. 10-0617396 (hereinafter, referred to as Patent Document 1) discloses a three-dimensional image display device capable of providing two or more parallax images within a minimum diameter of a pupil of an eye. However, in Patent Document 1, in order to provide two or more parallax images within the pupil, a parallax image providing unit including a laser light source, an optical diffuser, and an optical modulator, and a parallax image converging unit including pinholes and lenses should be provided, and thus, there is a problem in that the size and volume of the three-dimensional image display device increase.

Korean Patent Registration No. 10-1059763 (hereinafter, referred to as Patent Document 2) discloses a three-dimensional image display device capable of providing a full parallax image by arranging two or more projection optical systems. However, in Patent Document 2, due to discretely distributed selective light sources, a flat panel, a two-dimensional arrangement of optionally openable and closable apertures, a transmissive micro-display, and use of at least three lenses, it is difficult to achieve a size of a head mounted display (HMD) on the commercial level.

Even in Korean Patent Registration No. 10-1919486 (hereinafter, referred to as Patent Document 3), a plurality of IP lenses or apertures or combinations thereof are used when a multifocal view is implemented, thereby resulting in a decrease in resolution of each parallax image. In Patent Document 3, since a plurality of IP lens or pinhole arrays are used on the same micro-display panel to spatially divide the resolution of the display, when the micro-display panel is used as a virtual reality (VR)/mixed reality (MR)/augmented reality (AR) device, a resolution of each parallax image is greatly decreased.

That is, in Patent Document 3, since a display area is partially divided and the lens array is used to provide a virtual image, a plurality of parallax images may be provided, but it is difficult to provide a high definition virtual image.

### RELATED ART DOCUMENTS

### Patent Documents

(Patent Document 1) Korean Patent Registration No. 10-0617396 (registered on Aug. 22, 2006)
(Patent Document 2) Korean Patent Registration No. 10-1059763 (registered on Aug. 22, 2011)
(Patent Document 3) Korean Patent Registration No. 10-1919486 (registered on Nov. 12, 2018)

### DISCLOSURE

### Technical Problem

The present invention is directed to controlling a width size and a position of light passing through a lens by using a dynamic aperture disposed adjacent to the lens, thereby controlling a position and a size of a convergence area of a virtual image formed at an eye pupil position of an observer.

The present invention is also directed to providing a virtual image formed through a lens and a dynamic aperture at an eye pupil of an observer using an entire resolution of a display.

### Technical Solution

According to an embodiment of the present invention, a near-eye display device includes a display, a first lens disposed in front of the display so as to be spaced apart from the display by a predetermined distance, a dynamic aperture adjustment element disposed adjacent to the first lens to dynamically control an aperture size of the first lens and a horizontal position of the aperture on a plane perpendicular to an optical axis, a main optics lens disposed to be spaced apart from the first lens by a predetermined distance, and a control system configured to control the dynamic aperture adjustment element, wherein an eye pupil of an observer is positioned in an exit pupil disposed to be spaced apart from the main optics lens by a predetermined distance, and a size and a horizontal position of the exit pupil are determined according to the size and the horizontal position of the aperture of the dynamic aperture adjustment element that are adjusted according to a control signal from the control system.

The size of the aperture of the dynamic aperture adjustment element may be adjusted such that the size of the exit pupil is within 2 mm that is smaller than a pupil size of the observer.

The dynamic aperture adjustment element may be a liquid crystal device (LCD) or an electronic shutter, in which a size and a horizontal position of an aperture thereof are adjustable according to the control signal from the control system.

The dynamic aperture adjustment element may have two or more horizontal positions of the apertures, and the apertures at the horizontal positions of the dynamic aperture adjustment element may be sequentially operated within one frame virtual image according to the control signal from the control system so that two or more exit pupils are sequentially disposed.

The control system may sequentially provide two or more parallax images to the display in synchronization with a change in aperture position of the dynamic aperture adjustment element to allow different parallax images to be disposed at positions of the exit pupils.

The near-eye display device may further include a pupil tracking device configured to track an eye pupil position of the observer, wherein the control system uses pupil tracking information acquired by the pupil tracking device to control the horizontal position of the aperture of the dynamic aperture adjustment element in real time such that the exit pupil is continuously disposed in the eye pupil of the observer.

The dynamic aperture adjustment element may generate two or more aperture arrangements rearranged according to a moving direction of the eye pupil of the observer tracked by the pupil tracking device, one dynamic aperture at each horizontal position of the dynamic aperture adjustment element is operated within one frame virtual image according to the control signal from the control system, and the exit pupil is always placed within a pupil diameter according to the moving direction of the eye pupil of the observer to enlarge a size of the exit pupil in the moving direction of the eye pupil of the observer.

The dynamic aperture adjustment element may generate two or more aperture arrangements rearranged according to a moving direction of the eye pupil of the observer tracked by the pupil tracking device, the apertures at the horizontal positions of the dynamic aperture adjustment element may be sequentially operated within one frame virtual image according to the control signal from the control system, and two or more exit pupils may be sequentially disposed according to the moving direction of the eye pupil of the observer to enlarge a size of the exit pupil in the moving direction of the eye pupil of the observer.

Two or more aperture positions of the dynamic aperture adjustment element may be arranged in a horizontal direction, a vertical direction, a diagonal direction, or a combination thereof on the plane perpendicular to the optical axis.

The control system may adjust the size of the aperture of the dynamic aperture element according to a set best virtual image position and a depth of focus range to adjust the size of the exit pupil at an eye pupil position such that a nearest image blur size formed on a retina at a nearest focus position of an eye is equal to a farthest image blur size of an image point formed on the retina at a farthest focus position of the eye, the nearest image blur size and the farthest image blur size are within ±20% of the same value as an image blur size due to diffraction, and a best position of an image point of a virtual image is an arithmetic mean position of a nearest focus position and a farthest focus position of the eye in a diopter unit.

The aperture of the dynamic aperture adjustment element may be an annular aperture including a circular light blocking portion in a circular aperture.

When a radius of the circular aperture is denoted by a and a radius of the circular light blocking portion is denoted by a₀, and when a ratio of the radius of the circular light blocking portion to the radius of the circular aperture is defined as β (≡a₀/a), β may be zero or more and 1/3 or less.

When a radius of the circular aperture is denoted by a and a radius of the circular light blocking portion is denoted by a₀, and when a ratio of the radius of the circular light blocking portion to the radius of the circular aperture is defined as β (≡a₀/a), β may be zero or more and 0.45 or less.

The control system may adjust the size of the aperture of the dynamic aperture adjustment element to be wide so as to decrease the depth of focus range at a best virtual image position set according to a type of the virtual image and to provide an image with increased resolution.

The near-eye display device may further include a display position adjustment element configured to adjust a distance between the display and the first lens, wherein the control system controls the display position adjustment element according to the set best virtual image position to adjust a best virtual image position.

The first lens may have a focal distance which is adjustable according to the control signal from the control system, and the control system may control the focal distance of the first lens according to the set best virtual image position to adjust a best virtual image position.

The near-eye display device may further include a pupil tracking device configured to track a focus adjustment position of the eye of the observer, wherein the control system uses pupil tracking information acquired by the pupil tracking device to control the display position adjustment element to form a best virtual image position close to a focus adjustment position of the eye of the observer.

The near-eye display device may further include a pupil tracking device configured to track a focus adjustment position of the eye of the observer, wherein the control system uses pupil tracking information acquired by the pupil tracking device to control the focal distance of the first lens to form the best virtual image position close to a focus adjustment position of the eye of the observer.

Two pupil tracking devices may be provided and may track convergence position information of both eyes of the observer, and the control system may control the display position adjustment element to form the best virtual image position close to a gaze convergence depth of the both eyes of the observer.

Two pupil tracking devices may be provided and may track convergence position information of both eyes of the observer, and the control system may control the focal distance of the first lens to form the best virtual image position close to a gaze convergence depth of the both eyes of the observer.

For an abnormal vision observer with nearsightedness or farsightedness, a vision correction value may be input to the control system to correct a position of the display corresponding to the set best virtual image position so that the best virtual image position is provided to the abnormal vision observer without wearing vision correction glasses.

The display position adjustment element may be a piezoelectric element configured to perform precise position control, a voice coil motor (VCM), or an LCD in which a refractive index thereof is changed according to an electrical signal to adjust an effective distance between the display and the first lens.

For an abnormal vision observer with nearsightedness or farsightedness, a vision correction value may be input to the control system to correct the focal distance of the first lens corresponding to the set best virtual image position so that the best virtual image position is provided to the abnormal vision observer without wearing vision correction glasses.

The first lens of which the focal distance is adjustable is a focus-tunable lens of which a precise focal distance is manually or electrically controllable, a polymer lens, a liquid lens, a liquid crystal lens, or a lens of which a refractive index is changed according to an electrical signal.

The display may include a plurality of pixels, adjacent pixels of each pixel may provide a first virtual image having first polarization and a second virtual image having second polarization which is orthogonal to the first polarization, the dynamic aperture adjustment element may include a polarization aperture set including a first aperture having the first polarization and a second aperture having the second polarization, and two virtual images of the display may be transferred to an eye pupil position of the observer through the polarization aperture set of the dynamic aperture adjustment element so that the exit pupil is expanded.

The first virtual image and the second virtual image may be parallax images.

The polarization aperture set of the dynamic aperture adjustment element may have two or more horizontal positions, and apertures at the horizontal positions of the dynamic aperture adjustment element may be sequentially operated in one frame virtual image according to the control signal from the control system to allow two or more exit pupils to be sequentially disposed so that the size of the exit pupil is enlarged.

The control system sequentially may provide two or more parallax images to the display in synchronization with a position change of the polarization aperture set of the dynamic aperture adjustment element so that different parallax images are disposed at positions of the exit pupils.

The near-eye display device may further include two external sight cameras, wherein an external image captured by the two external panorama cameras is combined with a virtual image in the display through the control system and provided to each of both eyes of the observer.

Information acquired by the pupil position tracking device may be transmitted to the control system, and the control system may provide an image of the two external sight cameras to each of the both eyes of observer as a parallax image for each eyeball through a dynamic aperture.

One or more near-eye display devices may be disposed with respect to a left eye and a right eye and may each further include a mirror configured to change an optical path between the dynamic aperture adjustment element and the main optics lens.

The near-eye display devices may be disposed with respect to a left eye and a right eye, respectively, and may each further include a polarization beam splitter between the dynamic aperture adjustment element and the main optics lens and further include a half-wave retarder between the polarization beam splitters, wherein, while light passing through a left side (or right side) dynamic aperture passes through the polarization beam splitter at a left side (or a right side) and the half-wave retarder, polarization thereof is converted, and the light is reflected by the polarization beam splitter at the right side (or the left side) and then travels to the main optics lens at a right side (or a left side).

The near-eye display device may further include a mirror configured to change an optical path between the dynamic aperture adjustment element and the polarization beam splitter.

According to another embodiment of the present invention, a near-eye display device include a display, a first lens disposed in front of the display so as to be spaced apart from the display by a predetermined distance, a dynamic aperture adjustment element disposed adjacent to the first lens to dynamically control an aperture size of the first lens and a horizontal position of an aperture thereof on a plane perpendicular to an optical axis, a reflective mirror disposed to be spaced apart from the first lens by a predetermined distance and configured to reflect a virtual image to a beam splitter, the beam splitter disposed such that a virtual image providing direction and an external viewing window direction do not interfere with each other and configured to allow the virtual image and an external image to be simultaneously provided to an observer, a trans-reflective concave mirror configured to reflect the virtual image to the observer and transmit the external image, and a control system configured to control the dynamic aperture adjustment element, wherein an eye pupil of the observer is positioned in an exit pupil disposed to be spaced apart from the trans-reflective concave mirror by a predetermined distance, and a size and a horizontal position of the exit pupil are determined according to a size and the horizontal position of the aperture of the dynamic aperture adjustment element which are adjusted according to a control signal from the control system.

The near-eye display device may further include a vision correction lens for an abnormal vision observer with nearsightedness or farsightedness provided on an outer surface of an external viewing window of the trans-reflective concave mirror.

The near-eye display device may further include a display position adjustment element configured to adjust a distance between the display position and the first lens, wherein the control system controls the display position adjustment element according to a set best virtual image position to adjust a best virtual image position.

The near-eye display device may further include a pupil tracking device configured to track an eye pupil position of the observer, wherein the control system uses pupil tracking information acquired by the pupil tracking device to control the display position adjustment element to form the best virtual image position close to a focus adjustment position of an eye of the observer.

The near-eye display device may further include a pupil tracking device configured to track an eye pupil position of the observer, wherein the control system uses pupil tracking information acquired by the pupil tracking device to control the focal distance of the first lens to form the best virtual image position close to a focus adjustment position of an eye of the observer.

Two pupil tracking devices may be provided and may track orientation point information of both eyes of the observer, and the control system may control the display position adjustment element to form the best virtual image position close to a convergence position of the both eyes of the observer.

Two pupil tracking devices may be provided and may track convergence position information of both eyes of the observer, and the control system may control the focal distance of the first lens to form the best virtual image position close to a convergence position of the both eyes of the observer.

For an abnormal vision observer with nearsightedness or farsightedness, a vision correction value may be input to the control system to correct a position of the display corresponding to the set best virtual image position so that a best observing position is provided to the abnormal vision observer without wearing vision correction glasses.

For an abnormal vision observer with nearsightedness or farsightedness, a vision correction value may be input to the control system to correct the focal distance of the first lens corresponding to the set best virtual image position so that a best observing position is provided to the abnormal vision observer without wearing vision correction glasses.

The near-eye display device may further include an external sight shielding component and two external sight cameras on an outer surface of an external viewing window of the trans-reflective concave mirror, wherein an external image captured by the two external sight cameras is combined with the virtual image in the display through the control system and provided to each of both eyes of the observer.

The external panorama shielding component may be an optionally detachable clip type or an element of which transmittance is adjustable according to an electrical control signal.

The external image of the two external sight cameras may be corrected in consideration of a corresponding eye pupil position of the observer and provided to each of the both eyes of the observer.

### Advantageous Effects

According to the present invention, a near-eye display device with an extended depth of focus can be implemented, and a size of a convergence area of a virtual image at an eye pupil position can be formed to be smaller than a pupil size changed according to a use environment, thereby providing a virtual image without degradation in image quality according to the pupil size.

In addition, even when a dynamic aperture having a partial size of an entire aperture is applied by applying a time division of a synchronized parallax image to the dynamic aperture having the partial size, a parallax image with a wide depth of focus can be additionally provided without reducing a size of an entire exit pupil.

Furthermore, a position of a reduced convergence area with a wide depth of focus at an eye pupil position (or a reduced exit pupil determined according to the convergence area) is changed by making reference to pupil position information of an eyeball, thereby continuously providing one best virtual image at some moment to a pupil of an eyeball within a farthest portion of an entire exit pupil.

In addition, a super multi-view image of a full parallax can be provided in a pupil in a time division method, thereby providing a virtual image similar to a hologram.

Furthermore, by applying an annular aperture that more efficiently controls a diffraction effect, it is possible to reduce the Airy radius due to a diffraction effect determined by diffraction at the same aperture size. Accordingly, a depth of focus range can be widened in the same optical system, and a modulation transfer function (MTF) value at a spatial frequency of a high frequency can be increased.

In addition, an observer having a (near-sighted or far-sighted) abnormal vision eyeball can efficiently view a virtual image without vision correction glasses by using a device of the present invention.

Furthermore, in an example in which an optical structure is applied to virtual reality (VR), augmented reality (AR), mixed reality (MR), or extended reality (XR), when the optical structure is applied to both eyes, a polarization beam splitter and a half-wave retarder are applied to light polarized by passing through a dynamic aperture, thereby reducing light loss and simultaneously reducing a volume of an entire optical system.

### DESCRIPTION OF DRAWINGS

The patent or application file contains at least one drawing executed in color. Copies of this patent or patent application publication with color drawings will be provided by the Office upon request and payment of the necessary fee.

FIG. 1 is a cross-sectional side view illustrating a basic configuration of a near-eye display device according to a first embodiment of the present invention.

FIGS. 2A to 2C are cross-sectional side views illustrating configurations for changing a size and a position of an exit pupil at an observer position by changing a size and a position of a dynamic aperture according to the first embodiment of the present invention.

FIG. 3 is a table showing a result of specifically calculating a depth of focus (DOF) range including a constant according to a size adjustment of an exit pupil at an observer position according to the first embodiment of the present invention

FIG. 4 is a graph showing a specific application example of a cycle per degree (CPD) and a design horizontal field of view (H_FOV) value of a virtual image implemented depending on a used display resolution according to the first embodiment of the present invention.

FIG. 5 is a schematic cross-sectional side view illustrating a signal transmission system of an entire exit pupil and a control system when a dynamic aperture is fully opened according to a second embodiment of the present invention.

FIGS. 6A to 6C are cross-sectional side views illustrating an embodiment in which three parallax images are synchronized with dynamic aperture positions and sequentially provided in one frame.

FIG. 7 is a cross-sectional side view conceptually illustrating a configuration in which three partial exit pupils (51, 52, and 53) at an eye pupil position formed due to a time division operation of dynamic apertures of FIG. 6 are formed in an entire exit pupil (50).

FIG. 8 is a cross-sectional side view illustrating a coupling structure of dynamic aperture control and a pupil tracking device according to a third embodiment of the present invention.

FIG. 9A is a cross-sectional side view illustrating a configuration for forming an area of a reduced exit pupil (52) when an eye pupil position of an observer is shifted in a left direction (−Y-axis) of an optical axis, and FIG. 9B is a cross-sectional side view illustrating a configuration for forming an area of a reduced exit pupil (53) when an eye pupil position of an observer is shifted in a right direction (+Y-axis) of an optical axis.

FIGS. 10A to 10D are cross-sectional views illustrating processes of setting an aperture position such that areas of farthest reduced exit pupils (52 and 53) of an entire exit pupil (50) providable by a system are positioned within an eye pupil size of an observer.

FIGS. 11A and 11B are cross-sectional views conceptually illustrating a situation in which a dynamic parallax image is provided at an eye pupil position according to a fourth embodiment of the present invention.

FIGS. 12A to 12C show plan views illustrating arrangement examples of a dynamic aperture according to the fourth embodiment of the present invention.

FIG. 13 is a graph showing a diffraction blur radius (Airy radius) of an image and a geometric blur radius formed on an eye retina according to a size (PD_{eye}) of a convergence area of an image point of a virtual image at an eye pupil position (that is, a size of an entire or partial exit pupil).

FIG. 14 is a graph showing modulation transfer function (MTF) values according to spatial frequency when the eye is focused on an image point at a nearest position (Dₙ), an image point at a farthest position (D_{f}), and an image point at a best image position (D_{best}) in a DOF range, respectively, according to a fifth embodiment of the present invention.

FIG. 15 is a graph showing a result of performing a computer simulation on spatial frequencies, at which MTF values are 0.1, 0.2, and 0.3, according to a size (PD_{eye}) of a convergence area of an image point of a virtual image.

FIG. 16 is a cross-sectional side view illustrating a near-eye display device to which a dynamic aperture is applied according to the fifth embodiment of the present invention.

FIG. 17 is a cross-sectional view side of a near-eye display device for improving optical performance through a change in shape of a dynamic aperture according to a sixth embodiment of the present invention.

FIG. 18 is a cross-sectional view illustrating a dynamic aperture when an annular dynamic aperture of FIG. 17 is viewed on a plane (X-Y plane) perpendicular to an optical axis.

FIGS. 19A and 19B are graphs showing changes in main optical characteristics at an eye pupil position according to β.

FIG. 20 is a graph showing a result of calculating normalized relative light distribution function values of a point spread function (PSF) on an eye retina according to three representative β values according to the sixth embodiment of the present invention.

FIG. 21 is a graph showing comparing MTF curves and DOFs of annular apertures (β=1/3 and β=0.45) and a circular aperture (β=0) in dynamic apertures according to the sixth embodiment of the present invention.

FIG. 22 is a view illustrating a configuration for adjusting a DOF according to a seventh embodiment of the present invention.

FIGS. 23A to 23C are a table and graphs showing a result of mathematically calculating a relationship between main variables for determining a DOF range according to the seventh embodiment of the present invention.

FIG. 24A is a cross-sectional side view illustrating a configuration for changing a best position of a virtual image by adjusting a display position according to an eighth embodiment of the present invention.

FIG. 24B shows cross-sectional side views illustrating a configuration for changing a best position of a virtual image by adjusting a focus of a first lens according to another embodiment of the eighth embodiment of the present invention.

FIG. 25A is a graph showing a positional relationship of a display for adjusting a virtual image formation position according to the eighth embodiment of the present invention.

FIG. 25B is a graph showing a focal distance relationship of the first lens for adjusting a virtual image formation position according to another embodiment of the eighth embodiment of the present invention.

FIG. 26A is a cross-sectional side view illustrating a configuration for adjusting a best position of a virtual image from an eye by adjusting a display distance from a first lens according to the eighth embodiment of the present invention.

FIG. 26B is a cross-sectional side view illustrating a configuration for adjusting a best position of a virtual image from an eye by adjusting a focal distance of the first lens according to another embodiment of the eighth embodiment of the present invention.

FIG. 27 is a cross-sectional side view illustrating pupil tracking devices for tracking the pupil center information of both eyes of an observer and a control system for receiving the eye pupil center information and calculating a gaze depth of both eyes to adjust a position at which a virtual image is formed in FIG. 26.

FIGS. 28A to 28C show cross-sectional side views illustrating a refractive power error of an eyeball according to normal vision and nearsightedness or farsightedness for describing a principle of correcting vision of an abnormal vision (near-sighted or far-sighted) observer according to a ninth embodiment of the present invention.

FIG. 29 shows cross-sectional side views illustrating structures for showing a principle of a correction lens for an abnormal vision (near-sighted or far-sighted) eyeball.

FIG. 30A is a cross-sectional side view illustrating a configuration for correcting vision of an abnormal vision observer by adjusting a display distance from a first lens according to the ninth embodiment of the present invention.

FIG. 30B is a cross-sectional side view illustrating a configuration for correcting vision of an abnormal vision observer by adjusting a focus of a first lens according to another embodiment of the ninth embodiment of the present invention.

FIG. 31A is a graph showing a specific best virtual image formation position (based on a diopter unit) and a display position adjustment according to the ninth embodiment of the present invention.

FIG. 31B is a graph showing a specific best virtual image formation position (based on a diopter unit) and a focal distance adjustment of a first lens according to another embodiment of the ninth embodiment of the present invention.

FIG. 32 is a cross-sectional side view for describing a dynamic aperture adjustment element to which a polarization aperture set is applied according to a tenth embodiment of the present invention.

FIG. 33 is a cross-sectional side view illustrating a near-eye display device when being used as an augmented reality (AR) device according to an eleventh embodiment of the present invention.

FIG. 34 is a cross-sectional side view illustrating a structure used as an AR device additionally provided with a vision correction lens according to a twelfth embodiment of the present invention.

FIG. 35 is a cross-sectional side view illustrating a configuration including a shielding component and an external sight camera in front of an external viewing window according to a thirteenth embodiment of the present invention and illustrates a case in which AR and mixed reality (MR) or extended reality (XR) are mixed by applying the shielding component for external light to an AR function as needed.

FIG. 36 illustrates a case in which an optical system is used as an MR or XR device according to a fourteenth embodiment of the present invention and illustrates a case in which an external sight camera is provided for each eyeball in FIG. 8.

FIG. 37 illustrates a case in which an optical structure is applied to both eyes when being applied to virtual reality (VR), AR, or MR according to another embodiment of the present invention.

FIGS. 38 and 39 are views for describing a volume of an entire optical system being decreased and light loss being minimized by a polarization beam splitter and a half-wave retarder being applied to light polarized by passing through a dynamic aperture when compared with FIG. 37.

### MODES OF THE INVENTION

Hereinafter, specific embodiments of the present invention will be described with reference to the accompanying drawings. In describing the present invention, detailed descriptions related to well-known functions or configurations obvious to those skilled in the art related to the present invention will be omitted in order to not unnecessarily obscure the essence of the present invention.

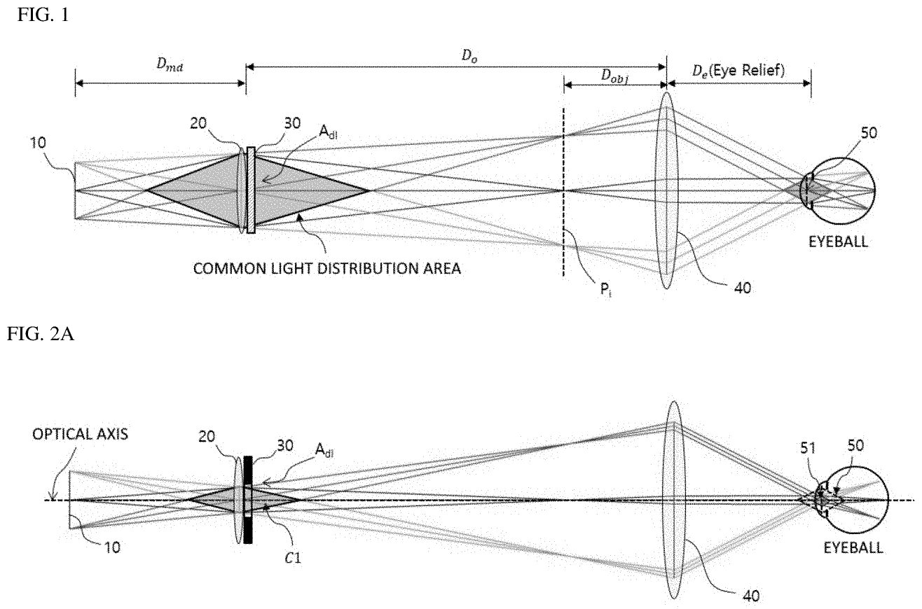

FIG. 1 is a cross-sectional side view illustrating a basic configuration of a near-eye display device according to a first embodiment of the present invention.

Referring to FIG. 1, the near-eye display device according to the first embodiment of the present invention includes a display 10, a first lens 20, a dynamic aperture adjustment element 30, a main optics lens 40, and a control system 60 (not shown).

The first lens 20 is disposed in front of the display 10 so as to be spaced apart from the display 10 by a first distance D_{md}. The dynamic aperture adjustment element 30 is disposed adjacent to the first lens 20 to dynamically control a size A_{dl} of an aperture of the first lens 20 and a horizontal position of an aperture thereof on a plane perpendicular to an optical axis. The dynamic aperture adjustment element 30 may be positioned between the display 10 and the first lens 20 or may be positioned between the first lens 20 and the main optics lens 40. In addition, when the first lens 20 may consist of several lens elements and groups, the dynamic aperture adjustment element 30 may be disposed inside the lens group. The main optics lens 40 is disposed to be spaced apart from the first lens 20 by a second distance Dₒ. An exit pupil 50 is disposed at a position spaced apart from the main optics lens by a third distance Dₑ. The control system 60 (not shown) controls the dynamic aperture adjustment element 30.

Virtual image information provided from an entire area of the display 10 generates an intermediate image on an intermediate image plane Pᵢ by using the first lens 20, and the generated intermediate image converges to an eye pupil of an observer at a predetermined distance (eye relief) Dₑ through the main optics lens. The near-eye display device has a basic configuration that allows the observer to view a virtual image at a predetermined distance D_{best} determined in such a manner.

Here, when the intermediate image is generated on the intermediate image plane Pᵢ in consideration of a distance relationship between the display 10 and the first lens 20, an image that is maintained in a ratio of 1:1, reduced, or enlarged may be generated. When the image is enlarged to be greater than a ratio of 1:1, a field of view (FOV) may be enlarged to be greater than a ratio of 1:1 in a state in which the predetermined distance (eye relief) Dₑ is maintained with the same display 10.

The first lens 20 and the main optics lens 40 are expressed as one thin lens (lens expressed as one principal plane) for convenience of description, but actually, the first lens 20 and the main optics lens 40 may be applied in the form of several lens elements and groups having the same effective focal distance to improve optical performance.

As shown in FIG. 1, an eye pupil of an observer is positioned in the exit pupil 50. Light generated from the entire area of the display forms a common light distribution area near the dynamic aperture adjustment element 30 and the first lens 20 and passes through the main optics lens 40 to form a convergence area at an eye pupil position spaced apart from the main optics lens 40 by the predetermined distance Dₑ. In this case, a maximum cross section of the convergence area on a plane (X-Y plane) perpendicular to the optical axis may be defined as the exit pupil 50. Therefore, the exit pupil has a size of a certain area on the plane (X-Y plane) perpendicular to the optical axis (Z-axis). Since it is not easy to illustrate the exit pupil 50 in the side view of FIG. 1, in the drawings of the present specification, for convenience of illustration, the convergence area at the eye pupil position is illustrated and specified as the exit pupil 50. In this case, an area of the exit pupil on the X-Y plane has a circular shape having a diameter size of PD_{eye}. In the following description, the diameter size will be described as a size PD_{eye} of the exit pupil or the convergence area at the eye pupil position. The size PD_{eye} of the exit pupil 50 and a center position of the exit pupil on the plane (X-Y plane) perpendicular to the optical axis (Z-axis) (hereinafter, specified as a horizontal position of the exit pupil) are changed according to an aperture size and a horizontal position of the dynamic aperture adjustment element 30 adjusted according to a control signal from the control system 60 (not shown). In this case, an aperture of the dynamic aperture adjustment element 30 has a circular shape on the plane (X-Y plane) perpendicular to the optical axis (Z-axis), a diameter size of the aperture is specified as an aperture size, and a center position of a dynamic aperture on the plane (X-Y plane) is specified as a horizontal position of the dynamic aperture.

The dynamic aperture adjustment element 30 may be disposed adjacent to the first lens 20, for example, in front or rear of the first lens 20, and the size A_{dl} of a dynamic aperture and a horizontal position of an aperture on the plane (X-Y plane) perpendicular to the optical axis may be adjusted to control a size and a position of the common light distribution area. The size of the common light distribution area is defined by a spatial area in which light beams emitted from the entire area of the display 10 are commonly present. According to the adjusted common light distribution area, the size PD_{eye} and horizontal position of the exit pupil 50 formed at an eye pupil position of an observer are determined. FIG. 1 illustrates the exit pupil 50 formed when the dynamic aperture is fully opened. In this case, the size of the exit pupil may be designed to be greater than a size of an eye pupil (3 mm to 4 mm) in a general environment.

The dynamic aperture adjustment element 30 may be a liquid crystal device (LCD) or an electronic shutter of which an aperture size and a horizontal position are changeable according to a control signal from the control system 60 (not shown). Specifically, in order to adjust the size A_{dl} and the horizontal position of the dynamic aperture, an LCD of which transmittance is locally adjustable according to application of an electrical signal, or other elements used as various types of electronic shutters may be used.

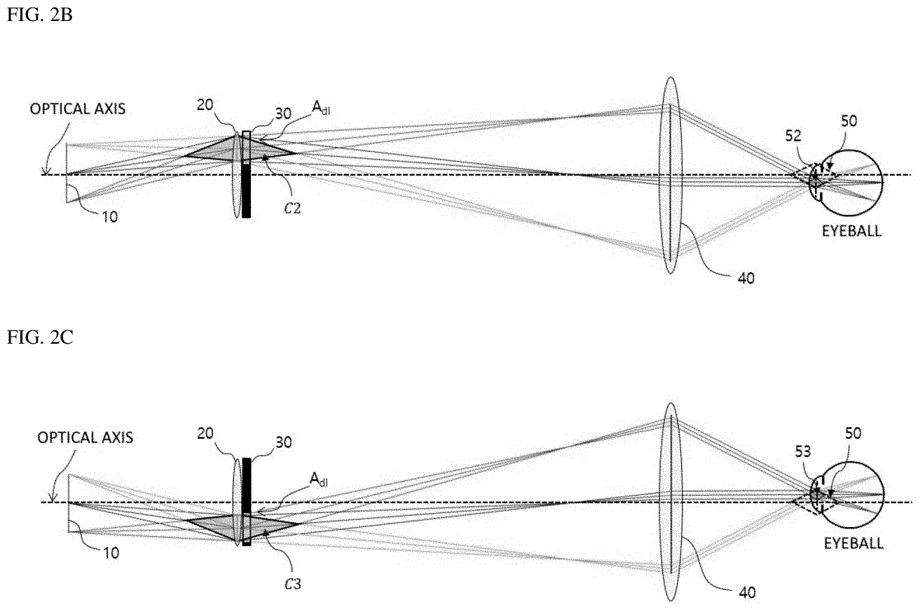

FIGS. 2A to 2C are cross-sectional side views illustrating configurations for changing a size and a position of an exit pupil at an observer position by changing a size A_{dl} and a position of a dynamic aperture according to the first embodiment of the present invention. In FIG. 2, a case in which the size A_{dl} of the dynamic aperture is decreased to ⅓ of that of an entire aperture will be described as an example, but a reduction ratio may be selected and applied according to the purpose.

FIG. 2A illustrates an embodiment in which a size A_{dl} of a dynamic aperture is decreased to ⅓ of that of an entire aperture and an aperture position is positioned at a center of the entire aperture. Since a common light distribution area C1 formed by the dynamic aperture is decreased, a size of a first exit pupil 51 at an observer position is decreased to 1/3 as compared with a case in which the entire aperture is opened. In this case, since the position of the dynamic aperture is positioned on an optical axis, a center position of the first exit pupil 51 is also positioned on the optical axis. The common light distribution area C1 and the exit pupil 51 formed in FIG. 2A are certain portions of the common light distribution area and an entire exit pupil 50 formed when the dynamic aperture is fully opened.

FIG. 2B illustrates an embodiment when a size A_{dl} of a dynamic aperture is 1/3 of that of an entire aperture and an aperture formation position is shifted in a +Y-axis direction to form the dynamic aperture. In this case, as in the previous case, sizes of a decreased common light distribution area C2 and a second exit pupil 52 at an observer position are decreased to 1/3 as compared with a case in which the entire aperture is opened. In addition, the common light distribution area C2 is shifted along a +Y-axis, and thus, the second exit pupil 52 at the observer position is formed by being shifted from an optical axis along a −Y-axis.

FIG. 2C illustrates a case in which a position of a dynamic aperture is shifted in a direction (−Y-axis) opposite to that of FIG. 2B and illustrates that an exit pupil 53 at an observer position which has the same size of that in FIG. 2B is formed by being shifted from an optical axis in an opposite direction (+Y-axis). In this case, within a size of the entire exit pupil 50 at an eye pupil position, the first to third exit pupils are disposed to have a size that is 1/3 of that of the entire exit pupil.

A shape of the dynamic aperture adjustment element 30 may be a circular shape and may be an elliptical shape or a polygonal shape as necessary. A shape of the exit pupil 50 is the same as the shape of the dynamic aperture adjustment element and the size of the exit pupil 50 remains the same or is reduced according to a ratio. In the case of the example, a size of the exit pupil 50 is reduced to 1/3.

According to the present invention, in a dynamic aperture disposed adjacent to the first lens 20, a position and a size of the exit pupils 50, 51, 52, and 53 positioned at an eye pupil position of an observer can be adjusted by controlling a width size and a position of light that is generated from the display 10 to pass through the first lens 12. The exit pupils 50, 51, 52, and 53 correspond to a size PD_{eye} of a convergence area of a virtual image. The size of the exit pupils 50, 51, 52, and 53 at an eye pupil position is directly related to a depth of focus (DOF) range of an eyeball. A specific relationship will be described as follows.

[DOF Range according to Size Adjustment of Exit Pupil]

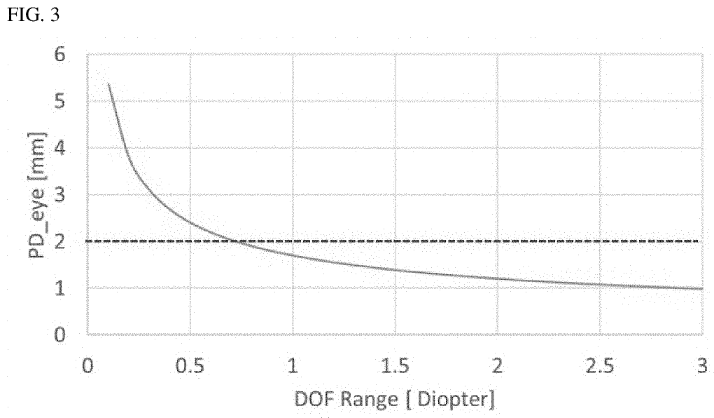

FIG. 3 is a table showing a result of specifically calculating a DOF range including a constant according to a size adjustment of an exit pupil according to the first embodiment of the present invention.

Referring to FIG. 3, a DOF range in a diopter unit has an inversely proportional relationship with a square of a size of an exit pupil at an eye pupil position.

DOF Range ∝1/(PD_{eye}) (Formula 1)

In order to express a clear virtual image from a virtual image at infinity (D_{far}=zero diopters) to a near distance Dₙₑₐᵣ of about 333 mm to 1,000 mm, which is a distance at which an interaction with the virtual image is easy, a system having a DOF range of three diopters to one diopter is required.

To this end, it is necessary to implement a size PD_{eye} of a convergence area of a virtual image within 2 mm. That is, in order to widen a DOF range, the control system 60 (not shown) may adjust the aperture size of the dynamic aperture adjustment element such that the size of the exit pupil 50 is within 2 mm, which is smaller than a pupil size of an observer.

[Adjustment of Horizontal Formation Position of Exit Pupil 50]

As an exit pupil 50 formed when a dynamic aperture is fully opened becomes smaller, a DOF range may be widened, but there is a problem of a reduction in horizontal position range in which a virtual image at an observer's eye position is visible.

In order to maintain a size of the exit pupil 50 when the dynamic aperture is fully opened, a position of the reduced dynamic aperture may be changed in real time by being combined with a time division dynamic aperture interlocking operation or a pupil position tracking device, thereby solving the problem of the reduction in size of the exit pupil 50.

According to the present embodiment, a near-eye display device with an extended DOF can be implemented, and a size of a convergence area of a virtual image can be formed to be smaller than a pupil size (of 2 mm to 8 mm) which is changed according to a use environment, thereby providing a virtual image without degradation in image quality according to a pupil size.

According to the present invention, by using a full resolution of the display, a virtual image, which is formed by being transferred through the first lens 20 and the dynamic aperture, can be provided at an eye pupil position of an observer.

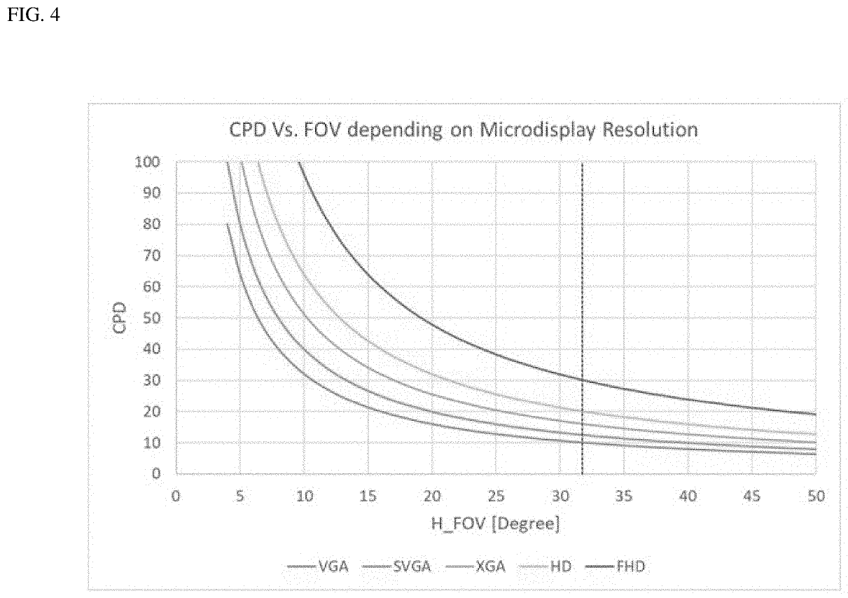

FIG. 4 is a graph showing a specific application example of a cycle per degree (CPD) and a design horizontal FOV (H_FOV) value of a virtual image implemented depending on used display resolution according to the first embodiment of the present invention. The first embodiment of the present invention will be described in detail as follows with reference to FIG. 4.

[Spatial resolution of Virtual Image according to Display Resolution and FOV]

When a resolution of the display 10 is determined and an FOV of a virtual image of a designed optical system is determined, a spatial resolution of a virtual image viewed by an observer may be expressed by a density of a maximum line-space pair image in an angle unit, which may be generated by the virtual image. This may be expressed in a CPD unit.

A horizontal resolution (H_Resolution), a horizontal FOV (H_FOV), and a CPD value of a virtual image have a relationship as in Formula 2 below.

$$CPD = \frac{1}{2} \frac{H\_Reseolution}{H\_FOV} \qquad ( Formula 2 )$$

A specific application example of a design H_FOV value depending on a resolution of the display 10 is as shown in FIG. 4.

For example, when a full high definition (FHD)-class (1920×1080) display is used to implement a virtual image with a horizontal FOV (H_FOV) of 32°, an image spatial resolution of 30 CPD may be provided. However, when a video graphics array (VGA)-class (640×480) display is applied, an image spatial resolution of 10.7 CPD, which is decreased to about 1/3 of 30 CPD, is provided.

According to the present embodiment, when virtual images having the same FOV are provided, a high spatial resolution virtual image can be provided to an observer as compared with the related art.

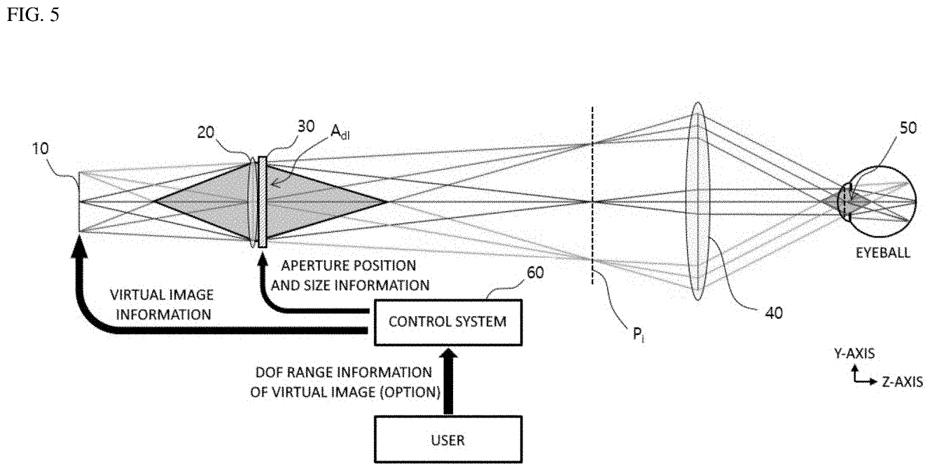

FIG. 5 is a schematic cross-sectional side view illustrating an entire exit pupil when a dynamic aperture is fully opened and a signal transmission system of a control system according to a second embodiment of the present invention.

Referring to FIG. 5, a dynamic aperture adjustment element 30 has two or more horizontal positions of apertures, and the apertures at local horizontal positions of the dynamic aperture adjustment element 30 are sequentially operated in one frame virtual image according to a control signal from a control system 60 to sequentially arrange two or more partial exit pupils in an exit pupil 50, thereby making full use of the size of the exit pupil 50.

In addition, the control system 60 sequentially provides two or more parallax images to a display in synchronization with changes in local aperture positions of the dynamic aperture adjustment element 30, thereby allowing different parallax images to be disposed at positions of two or more partial exit pupils in the exit pupil 50.

When a dynamic aperture is fully opened, the entire exit pupil 50 at an eye pupil position of an observer may be designed to have a size of 4 mm or more and thus may be designed such that a clearance according to a movement range of an eye pupil and an interpupillary distance of a user is sufficient.

The control system 60 determines a necessary size A_{dl} of the dynamic aperture according to a depth range of a virtual image manually input by a user or a depth range automatically determined according to the type or need of a virtual image such as a two-dimensional text image or a three-dimensional virtual image, thereby transferring the determined size A_{dl} to the dynamic aperture adjustment element 30.

In addition, when provided parallax images are provided to a display 10, the control system 60 synchronizes the partial exit pupils 51, 52, and 53 at an eye pupil position formed according to a dynamic aperture position and parallax images corresponding thereto, and provides sequentially them by dividing time within a frame, thereby allowing partial exit pupils 51, 52, and 53 in the entire exit pupil 50, in which different parallax images are provided to an observer, to be sequentially formed on a plane (X-Y plane) perpendicular to an optical axis.

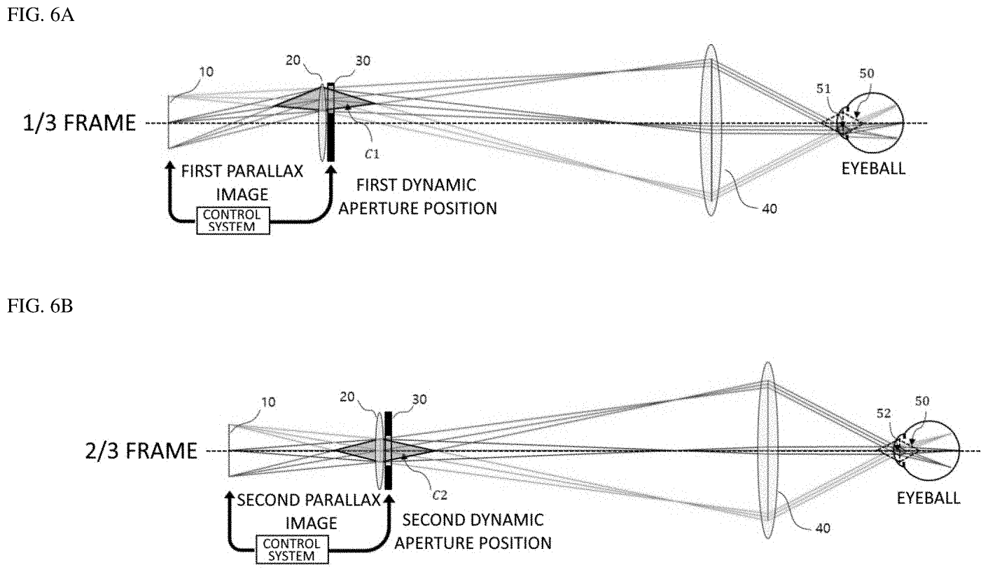

FIGS. 6A to 6C are cross-sectional side views illustrating an embodiment in which three parallax images are synchronized with dynamic aperture positions and sequentially provided in one frame. FIGS. 6A, 6B, and 6C illustrate structures for controlling a dynamic aperture and providing a parallax image, which respectively correspond to a 1/3 frame, a 2/3 frame, and a 3/3 frame.

Referring to FIGS. 6A to 6C, three dynamic apertures disposed in a direction (Y-axis direction) perpendicular to an optical axis may be sequentially operated during one frame, and synchronized parallax images may be provided to the display. Three parallax images are synchronized with the dynamic aperture positions and are sequentially provided in one frame, and thus, three different parallax images may be provided to the partial exit pupils 51, 52, and 53 at an eye pupil position. As a result, when one frame is 30 Hz or more (90 Hz or more based on a frame during which three parallax images are provided), a user recognizes a combination of the partial exit pupils 51, 52, and 53 which provide three parallax images in the entire exit pupil 50 due to an afterimage effect of an eyeball.

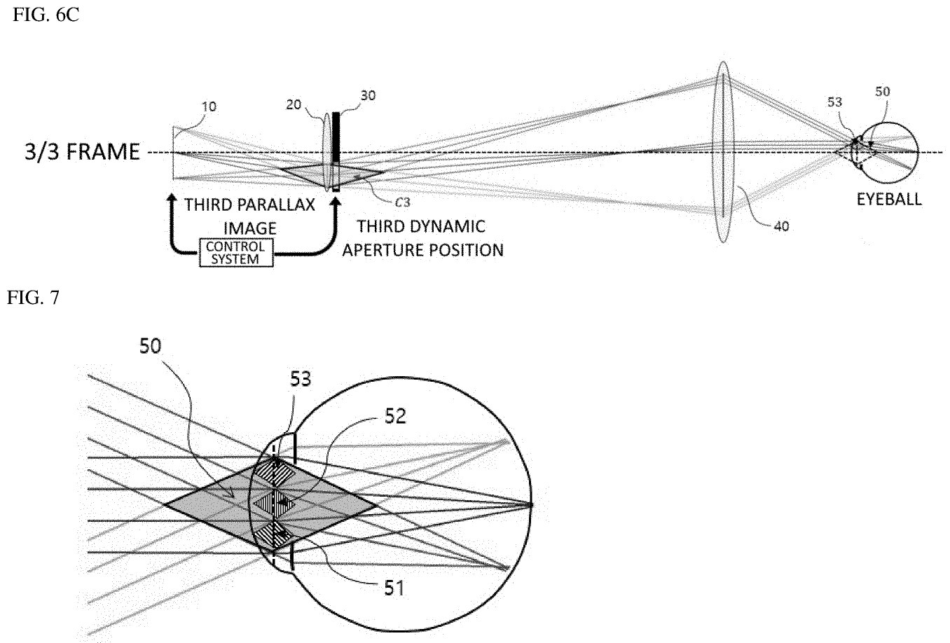

FIG. 7 is a cross-sectional side view conceptually illustrating a configuration in which three partial exit pupils 51, 52, and 53 at an eye pupil position formed due to a time division operation of the dynamic apertures of FIG. 6 are formed in the entire exit pupil 50. In optical paths, only optical paths for the formation of the entire exit pupil 50 are illustrated in FIG. 7.

Although the above embodiment of the present invention has been described based on the dynamic apertures disposed in a straight line in one direction (Y-axis direction) perpendicular to an optical axis, the dynamic apertures may be two-dimensionally disposed on a plane (X-Y plane) perpendicular to the optical axis. Actually, in order to effectively use parallax images, it is efficient when apertures are disposed in the same direction as an arrangement of both eyes of an observer (Y-axis direction in the present embodiment), but in order to effectively increase the number of parallax images, dynamic apertures may be two-dimensionally disposed on the X-Y plane to increase the number of the partial exit pupils 51, 52, and 53 which provide parallax images.

In addition, in the above embodiment of the present invention, although a case in which the partial exit pupils 51, 52, and 53 formed by adjacent dynamic apertures are disposed adjacent to each other without empty space therebetween has been described as an example, there may be an empty space between adjacent exit pupils 51, 52, and 53, and when the number of parallax images is increased or the size A_{dl} of the dynamic aperture is increased according to an adjustment of a DOF range, the adjacent exit pupils 51, 52, and 53 may be formed such that certain portions thereof overlap each other.

According to the present embodiment, in the present invention, in order to solve a problem in that a size of the entire exit pupil 50 is decreased due to a size of the partial exit pupils 51, 52, and 53 formed at an eye pupil position being formed within 2 mm so as to widen a DOF range by applying a dynamic aperture, a combination of two or more partial exit pupils 51, 52, and 53, which provide parallax images with an extended DOF range, can be made in the entire exit pupil 50. Accordingly, in the above embodiment, even when a dynamic aperture having a partial size of an entire aperture is applied, a parallax image having a wide DOF range can be additionally provided without reducing the size of the entire exit pupil 50.

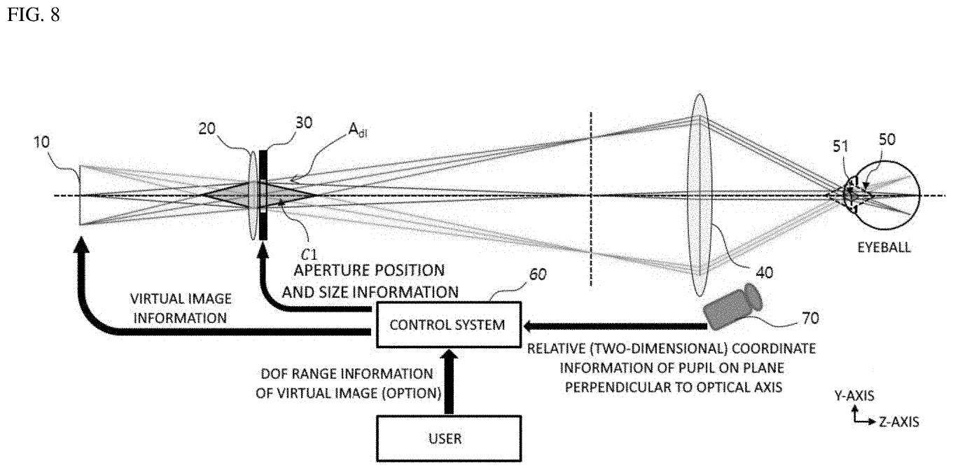

FIG. 8 is a cross-sectional side view illustrating a coupling structure of dynamic aperture control and a pupil tracking device according to a third embodiment of the present invention.

Referring to FIG. 8, a near-eye display device may include a pupil tracking device 70 for tracking an eye pupil position of an observer. The control system 60 may use pupil tracking information acquired by the pupil tracking device 70 to control a horizontal position of an aperture of a dynamic aperture adjustment element 30 in real time such that a partial exit pupil 51 may be continuously disposed in an eye pupil of the observer.

When a pupil center of an eyeball of the observer is near a center of an optical axis, and when a center of a dynamic aperture is set on the optical axis, the partial exit pupil 51 is formed at a position near the pupil center of the eyeball due to a common light distribution formation area C1 formed by the dynamic aperture.

An entire exit pupil 50 at an eye pupil position of an observer, which is formed when the dynamic aperture is fully opened, may be designed to have a size of 4 mm or more, and thus, the entire exit pupil 50 may be designed such that a clearance according to a movement range of a pupil and an interpupillary distance of a user is sufficient.

The control system 60 determines a necessary size A_{dl} of the dynamic aperture according to a depth range of a virtual image manually input by a user or a depth range automatically determined according to the type of a virtual image (such as a two-dimensional text image or a three-dimensional virtual image), thereby transferring the determined size A_{dl} to the dynamic aperture adjustment element 30.

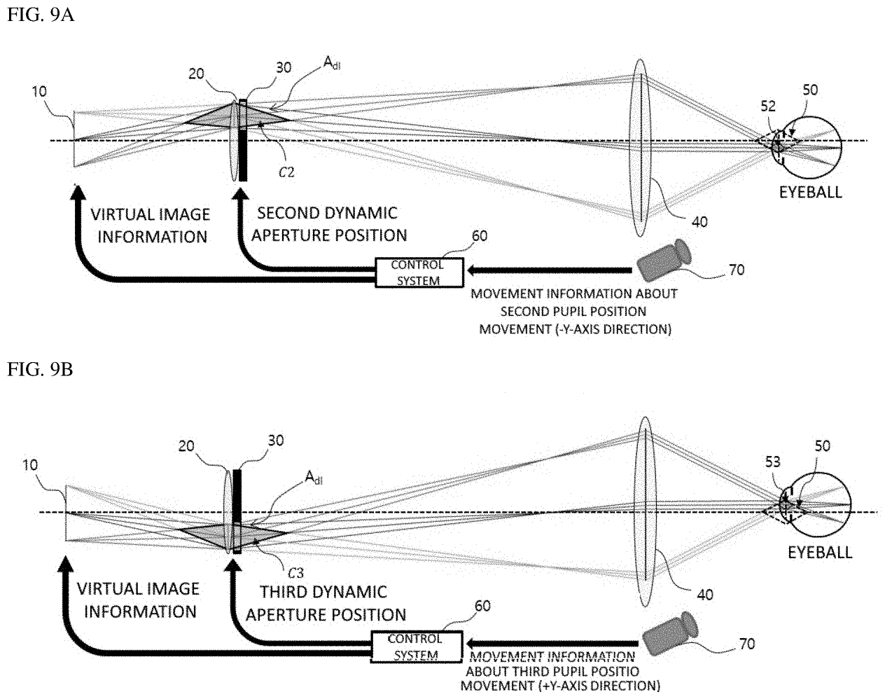

FIG. 9A is a cross-sectional side view illustrating a configuration for forming a partial exit pupil 52 when an eye pupil position of an observer is shifted in a left direction (−Y-axis) of an optical axis. FIG. 9B is a cross-sectional side view illustrating a configuration for forming a partial exit pupil 53 when an eye pupil position of an observer is shifted in a right direction (+Y-axis) of an optical axis.

Referring to FIGS. 9A and 9B, the dynamic aperture adjustment element 30 has two or more horizontal positions of apertures. The aperture is rearranged according to a moving direction of an eye pupil measured by the pupil tracking device 70, and the apertures at horizontal positions of the dynamic aperture adjustment element 30 are sequentially operated in one frame virtual image according to a control signal from the control system 60, thereby sequentially arranging two or more partial exit pupils 52 and 53 according to a moving direction of the eye pupil of an observer. Accordingly, even when the partial exit pupils 52 and 53, which are formed in synchronization with a shifting direction of an eye pupil position of the observer, are used, it is possible to provide a best virtual image with respect to an eye pupil movement in an entire exit pupil 50. As a result, the entire exit pupil 50 can be effectively used. In addition, it is possible to select one dynamic partial exit pupil 51, 52, or 53 close to a center of a moving pupil in one frame virtual image.

When the pupil tracking device 70 for tracking an eye pupil position of an observer in real time transmits pupil position information of an eyeball to the control system 60 in real time, the control system 60 changes a size A_{dl} of a dynamic aperture determined according to a DOF range and a center position of the dynamic aperture corresponding to a center position of an eye pupil of an observer to change positions of the dynamic partial exit pupils 51, 52, and 53 at the eye pupil position in real time. In the present embodiment, a center position of a dynamic aperture is shifted on a plane (X-Y plane) perpendicular to the optical axis, and the center position of the dynamic aperture on the plane is in a direction opposite to an eye pupil movement of an observer.

That is, when the observer moves in a +Y-direction, the dynamic aperture is moved in a −Y-direction, and an amount of movement is determined according to a design of a ratio of a second distance Dₒ to a third distance Dₑ of an optical system. For example, when the ratio of the second distance Dₒ to the third distance Dₒ is 2:1, the center position of the dynamic aperture may be shifted by 2 mm in order to move the dynamic partial exit pupils 52 and 53 at an eye pupil position by 1 mm.

Referring to FIG. 9A, when the eye pupil position of the observer is shifted in the left direction (−Y-axis) of the optical axis, the control system 60, which receives feedback of a direction and amount of movement from a captured image of the pupil tracking device, operates to transfer the received feedback to the dynamic aperture adjustment element 30 and form a second common light distribution area C2 according to a change in second dynamic aperture position so that the reduced partial exit pupil 52 is formed near a pupil center of an eyeball.

Referring to FIG. 9B, when the eye pupil position of the observer is shifted in the right direction (+Y-axis) of the optical axis, the control system 60, which receives feedback of a direction and amount of movement from a captured image of the pupil tracking device, operates to transfer the received feedback to the dynamic aperture adjustment element 30 and form a third common light distribution area C3 according to a change in third dynamic aperture position so that the reduced partial exit pupil 53 is formed near a pupil center of an eyeball.

Embodiments of a coupling structure of dynamic aperture control and a pupil tracking device and an operating method of the present invention will be described as follows.

[When Eye pupil Center of Observer Exceeds Range of Available Entire Exit Pupil 50]

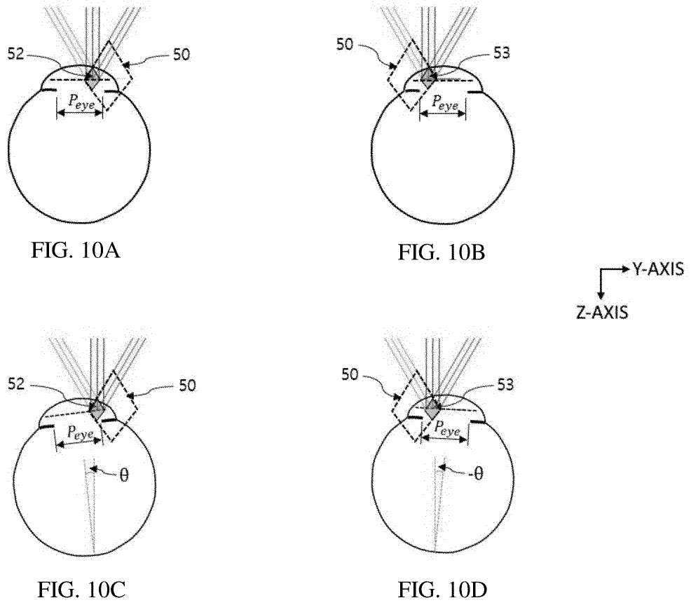

FIGS. 10A, 10B, 10C, and 10D are cross-sectional views illustrating processes of setting an aperture position such that farthest reduced partial exit pupils 52 and 53 providable by a system are positioned within an eye pupil of an observer. FIGS. 10A and 10B are views of a case in which an eye pupil is moved in a horizontal direction (Y-axis direction). The case corresponds to a case where the pupil distance of both eyes of the observer do not match the optical system. However, ideally, when pupils of both eyes of the observer are initially set to optical axes, as the observer changes a gaze direction of an eye, eyeball rotation may occur. Accordingly, the horizontal direction (Y-axis direction) of the eye pupil may be changed. The case is illustrated in FIGS. 10C and 10D. The embodiment of the present invention is applicable to both of the two cases. In the application of the above-described embodiments of the present invention, when a center position of an eye pupil of an observer is shifted beyond an area of an entire exit pupil 50 which is providable by a design of an optical system of the present invention, it is difficult to precisely apply the embodiments of the present invention. However, when a certain area of the entire exit pupil 50 overlaps an edge of a pupil, a virtual image may be visible. Therefore, in the practical application of the present invention, a size of the entire exit pupil 50 at an eye pupil position should be set in consideration of the pupil movement range of the observer's eye.

Specifically, in the situations of FIGS. 9A and 9B, when an amount of pupil movement of an observer cannot be set to a pupil center even when a farthest aperture area of a dynamic aperture is used, as shown in FIGS. 10A and 10B (or FIGS. 10C and 10D), the control system 60 sets an aperture position of the dynamic aperture adjustment element 30 such that the farthest reduced partial exit pupils 52 and 53 providable by the system are positioned within an eye pupil size P_{eye} of the observer.

According to the present embodiment, in the preceding embodiment, the partial exit pupils 51, 52, and 53 having parallax images are formed by applying a time division to the entire exit pupil 50 without eye pupil tracking, thereby providing a parallax image and a virtual image with a wide DOF range while using most of the entire exit pupil 50, but in the present embodiment, positions of the reduced partial exit pupils 51, 52, and 53 with a wide DOF range at an eye pupil position are changed by making reference to pupil position information of an eyeball, thereby continuously providing a best virtual image to an eye pupil within a farthest portion of the entire exit pupil 50.

Hereinafter, a dynamic aperture being controlled by simultaneously using a parallax image provision and eye pupil tracking information according to a fourth embodiment of the present invention will be described.

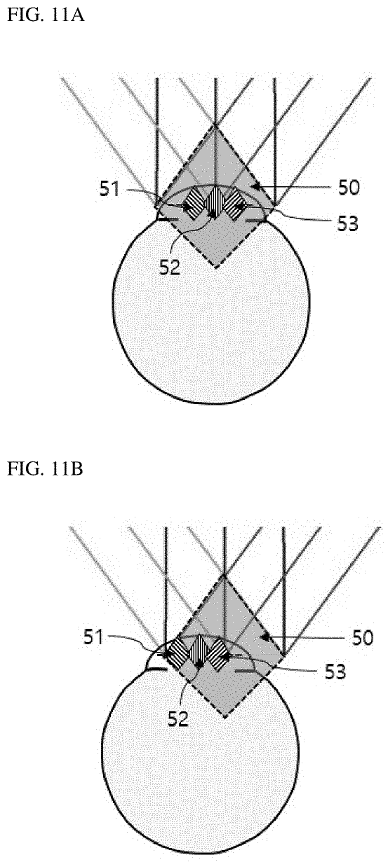

FIGS. 11A and 11B are cross-sectional views conceptually illustrating a situation in which a dynamic parallax image is provided at an eye pupil position according to the fourth embodiment of the present invention. FIG. 11 illustrates a case in which an eye pupil of an observer is moved in a horizontal direction (Y-axis direction) and thus a pupil is moved in the horizontal direction (Y-axis direction) and may also be reflected even in a case in which an eyeball is rotated and thus a pupil is moved in the horizontal direction (Y-axis direction) as shown in FIGS. 10C and 10D. For convenience, FIG. 11 illustrates only a horizontal movement of an eyeball.

When an embodiment in which three parallax images are dynamically formed is described as an example with reference to FIGS. 8, 11A, and 11B, a pupil tracking device 70 transmits pupil position coordinate information of an eyeball of an observer to a control system 60. The control system 60 sequentially operates three dynamic apertures in one frame such that an intermediate partial exit pupil 52 is positioned at pupil center coordinates among partial exit pupils 51, 52, and 53 which provide three parallax images. In this case, the control system 60 allows a display 10 to provide a parallax image in synchronization with an operating aperture of the dynamic apertures. Here, the description has been given in simple consideration of only one-dimensional direction (Y-axis direction) of a pupil, but actually, of course, a position of a dynamic aperture may be adjusted with respect to two-dimensional (X-Y plane) information about a pupil. FIG. 11A illustrates a situation in which a pupil position is positioned on an optical axis of an optical system, that is, a situation in which the pupil position is positioned at a center of an entire exit pupil 50 when a dynamic aperture is fully opened. When a pupil size of an observer corresponds to approximately a total width of the partial exit pupils 51, 52, and 53 which provides three parallax images, a super multi-view image is provided to a pupil of the observer, thereby providing a realistic three-dimensional image similar to a hologram to the observer. In this case, the intermediate partial exit pupil 52 is positioned at a pupil center of the observer.

FIG. 11B illustrates a result in which, when a pupil center of an observer is shifted to the left (−Y-direction), the dynamic aperture is adjusted to allow the partial exit pupil 52 having an intermediate parallax to be disposed at a center position of an eye pupil in the entire exit pupil 50, thereby sequentially providing parallax images in one frame.

However, when a center position of an eye pupil is shifted to the outside of the entire exit pupil 50 that is controllable with a dynamic aperture, as described in the third embodiment, the partial exit pupil 52 that provides a central parallax image cannot be aligned with a pupil center, and as in the method described in the third embodiment, a parallax image is provided to the farthest partial exit pupil 52 or 53 (see FIG. 10) of the dynamic aperture. On the other hand, when a pupil center position is shifted to the outside of the entire exit pupil 50, as necessary, the provision of some time-division parallax images may be restricted.

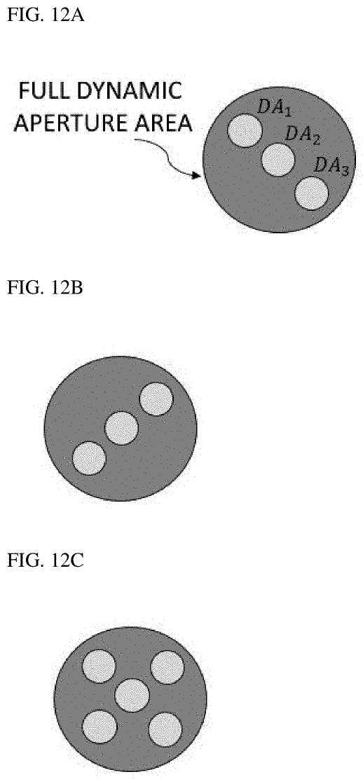

FIGS. 12A to 12C show plan views illustrating arrangement examples of a dynamic aperture according to the fourth embodiment of the present invention.

Referring to FIGS. 12A to C, two or more horizontal positions of apertures of a dynamic aperture adjustment element 30 may be disposed in a horizontal direction, a vertical direction, a diagonal direction, or a combination there on an X-Y plane.

In the above-described embodiment, a case in which an eye pupil position is shifted only in a one-dimensional direction has been described as an example, but actually, a pupil may be two-dimensionally moved on a plane (X-Y plane) perpendicular to an optical axis of an optical system. In this case, in order to effectively allow a moving speed of a pupil to correspond to a reaction speed of dynamic apertures, positions of the plurality of dynamic apertures may be variously set.

Among these, FIGS. 12A to 12C illustrate some possible arrangements of dynamic apertures. FIGS. 12A to 12C are merely an example, and actually, dynamic apertures may be variously disposed, adjacent dynamic apertures may overlap each other according to DOF range setting, and the control system 60 (not shown) may process an algorithm to change the number and positions of dynamic apertures generated according to a type of virtual image viewed by a user and a measured pupil size.

According to embodiments of the present invention, when parallax images, in which a two-dimensional dynamic aperture and a time division are used, are two-dimensionally provided, a super multi-view images with full parallax can be provided in a pupil, thereby simulating artificial light focusing and defocusing to provide virtual images similar to a hologram.

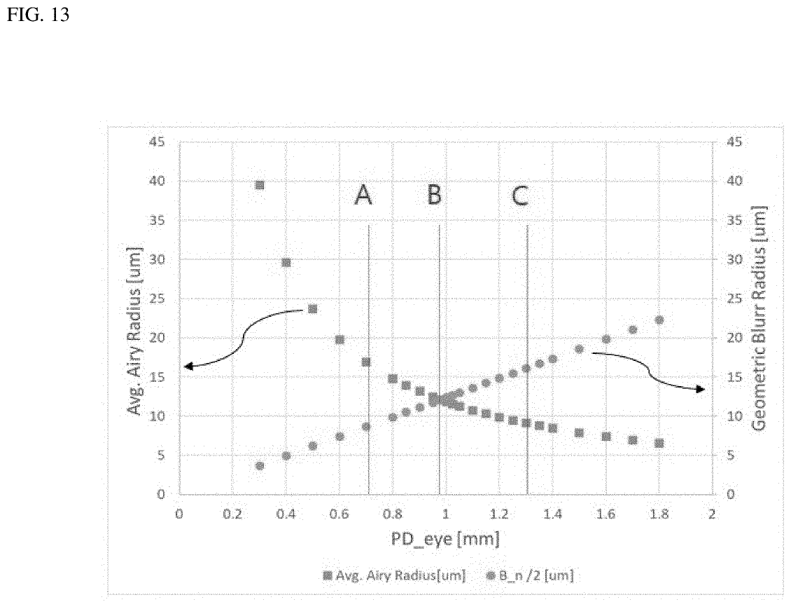

Hereinafter, a DOF range adjusting method and an operation structure according to a fifth embodiment of the present invention will be described with reference to FIGS. 13 to 16. FIG. 13 is a graph showing a diffraction blur radius (Airy radius) and a geometric blur radius of an image formed on an eye retina according to a size PD_{eye} of a convergence area of an image point of a virtual image at an eye pupil position (that is, a size of an entire or partial exit pupil).

Referring to FIG. 13, a distance, in which the Airy radius due to a diffraction effect is equal to the geometric blur radius on the eye retina when a focus of an eye is out of focus at a best distance D_{best}, is set with a nearest distance Dₙ, and a farthest distance D_{f}, and an inner range thereof is defined as a DOF range, that is, an area in which a user does not feel a difference in image quality.

As described above with reference to FIG. 3, a DOF range has an inversely proportional relationship with a square of a size of dynamic partial exit pupils 51, 52, and 53 formed at an eye pupil position (size of a convergence area of a virtual image associated with the dynamic partial exit pupils 51, 52, and 53) (see Formula 1).

As described in the first embodiment, by adjusting the size A_{dl} of a dynamic aperture, the exit pupil at the eye pupil position can be adjusted to one of the partial exit pupils 51, 52, and 53 which is a part of the size of an entire exit pupil 50, thereby the size PD_{eye} of the convergence area of the image point of the virtual image may be adjusted.

In the embodiment of FIG. 13, in a case of constituting an optical system having a DOF range of three diopters (for example, Dₙ=three diopters (=333 mm) and D_{f}=zero diopters (=infinite distance)), at the nearest distance or farthest distance Dₙ or D_{f}, the diffraction Airy radius and the geometric blur radius on the eye retina tend to be increased and decreased in opposite directions according to the size PD_{eye} of the convergence area of the image point of the virtual image. In this case, the size PD_{eye} of the convergence area, in which the diffraction Airy radius is equal to the geometric blur radius, corresponds to position B in the present embodiment. In conditions of the size PD_{eye} of the convergence area at positions A and C, a diffraction or geometric blurring effect is increased, and thus, image blurring is increased as compared with position B, thereby reducing a DOF range.

The present embodiment corresponds to a case in which a DOF range is three diopters, and when the size PD_{eye} of the convergence area at the image point of the virtual image is 0.978 mm, the diffraction Airy radius and the geometric blur radius have the same radius value of 12.12 μm. In this case, a wavelength λ and an effective axial eye length d_{eye} of an eyeball used for calculating in embodiments of the present invention are 0.587 μm and 16.535 mm.

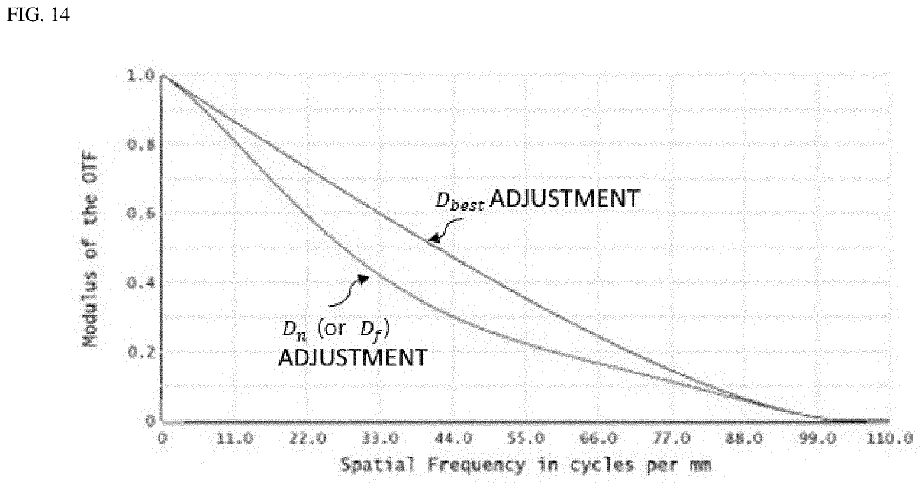

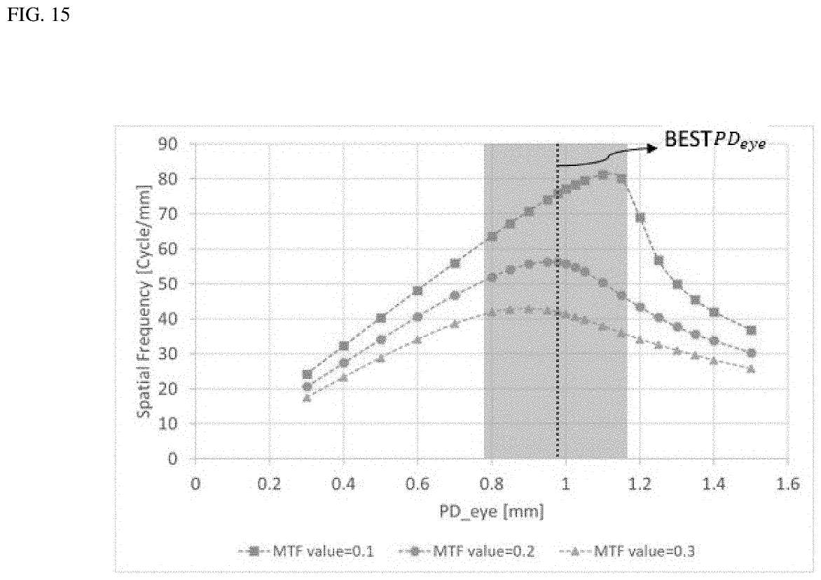

FIG. 14 is a graph showing modulation transfer function (MTF) values according to spatial frequency in a retina when the eye is focused on an image point at a nearest position Dₙ, an image point at a farthest position D_{f}, and an image point at a best image position D_{best} in a DOF range, respectively, according to the fifth embodiment of the present invention. FIG. 15 is a graph showing a result of performing a computer simulation on spatial frequencies, at which MTF values are 0.1, 0.2, and 0.3, according to a size PD_{eye} of a convergence area of an image point of a virtual image.

A configuration for determining a range of the size PD_{eye} of the convergence area according to a DOF range will be described in detail as follows.

When the DOF range is determined as described above, the optimal size PD_{eye} of the convergence area has a value at which a diffraction Airy radius is equal to a geometric blur radius on the eye retina. In this case, an MTF characteristic when an eye is focused on the best virtual image position D_{best} is not the same as an MTF characteristic when a focus is adjusted on the nearest distance or farthest distance Dₙ or D_{f}, and as shown in FIG. 14, it can be seen that an MTF value is decreased according to a spatial frequency.

As a result, according to a maximum spatial frequency value of the virtual image implemented in consideration of a resolution of a display and FOV of a designed optical system, the optimal size PD_{eye} of a convergence area of an image point of a virtual image, which is defined in a condition in which diffraction Airy radius is equal to geometric blur radius, may vary depending on the designed maximum spatial frequency value.

A cut-off spatial frequency of an MTF determined according to an optical design may be changed, but changes in MTF values according to the spatial frequency in which the cut-off spatial frequency is normalized to one are the same. Accordingly, a maximum usable spatial frequency in consideration of observer's visibility in a designed optical system actually has an MTF value of 0.1 to 0.3. FIG. 15 shows the result of the computer simulation on the spatial frequencies, at which representative MTF values are 0.1, 0.2, and 0.3, according to the size PD_{eye} of the convergence area of the image point of the virtual image.

As shown in the result, the size PD_{eye} of the convergence area of the image point of the virtual image, at which a maximum spatial frequency is provided according to a reference MTF value, is changed from a best condition. Such a range is about ±20% of the optimal size PD_{eye} of a convergence area of an image point of a virtual image. Within the range, it is possible to adjust and use the size PD_{eye} of the convergence area of an image point of a virtual image, which is determined according to a suitable DOF range according to the priority of optical design.

Therefore, a control system 60 (not shown) may adjust an aperture size of a dynamic aperture adjustment element according to a set best virtual image position and the DOF range to adjust a size of an exit pupil at eye pupil position such that a nearest image blur size of an image point formed on a retina at a nearest focus position of an eye is equal to a farthest image blur size of an image point formed on a retina at a farthest focus position of an eye, the nearest image blur size and the farthest image blur size are in a range of ±20% of the same value as an image blur size (Airy disk) due to diffraction, and a best position of an image point of a virtual image is an arithmetic mean position of the nearest focus position and the farthest focus position of the eye in a diopter unit.

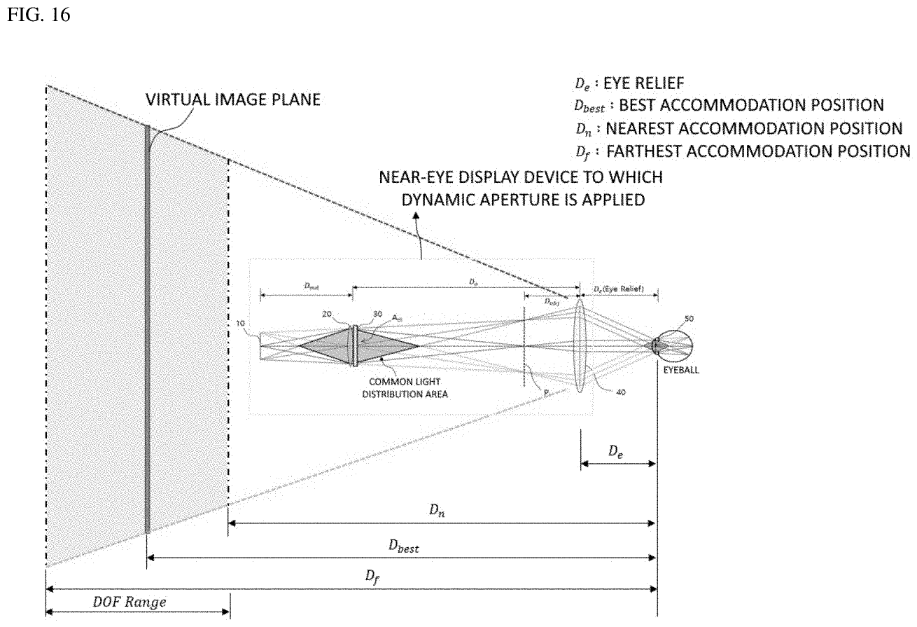

FIG. 16 is a cross-sectional side view illustrating a near-eye display device to which a dynamic aperture is applied according to the fifth embodiment of the present invention.

The adjustment of a DOF range and a best virtual image formation position according to the present invention will be described as follows with reference to FIG. 16.

When a DOF range is determined according to a size PD_{eye} of a convergence area of an image point of a virtual image as described above, a best virtual image formation position D_{best} is determined as an arithmetic mean position of a nearest distance Dₙ and a farthest distance D_{f} of the DOF range (D_{best}=(Dₙ+D_{f})/2). In this case, each distance unit is a diopter unit. When being expressed in a distance unit in meters, it should be noted that the best virtual image formation position D_{best} does not have a relationship with an arithmetic mean of farthest distance and nearest distance of a DOF range.

In embodiments of the present invention, FIG. 16 conceptually shows the near-eye display device to which the dynamic aperture is applied, a DOF range determined according to the near-eye display device, and a relationship between main variables related to the formation of a best virtual image position.

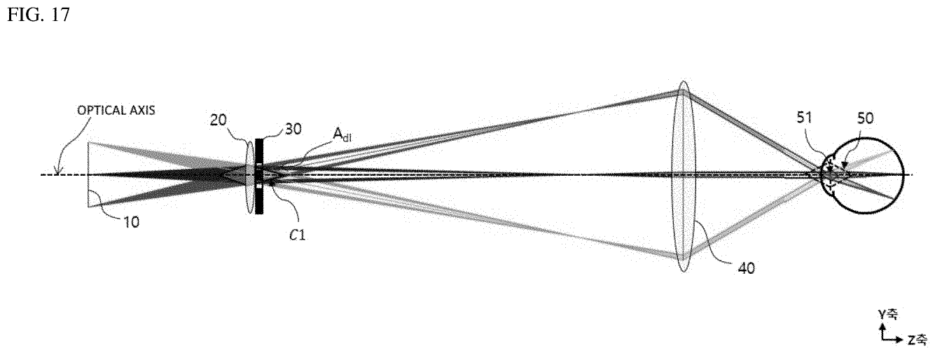

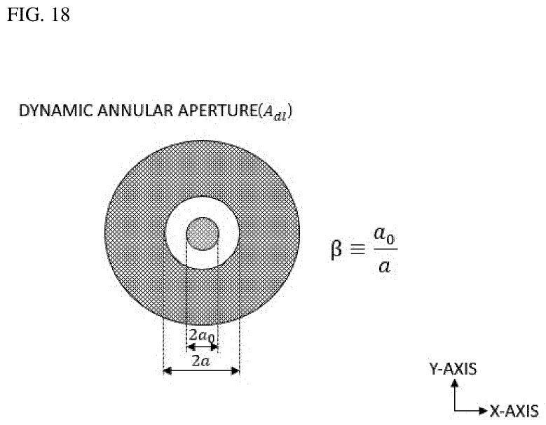

FIG. 17 is a cross-sectional view side of a near-eye display device for improving optical performance through a change in shape of a dynamic aperture according to a sixth embodiment of the present invention. FIG. 18 is a cross-sectional view illustrating a dynamic aperture when an annular dynamic aperture of FIG. 17 is viewed on a plane (X-Y plane) perpendicular to an optical axis.

A principle of improving optical characteristics according to a change in shape of a dynamic aperture (annular aperture) will be described as follows with reference to FIG. 17.

As shown in FIG. 18, an aperture of a dynamic aperture adjustment element 30 is an annular aperture including a circular light blocking portion in a circular aperture. When a radius of the circular aperture is denoted by a and a radius of the circular light blocking portion is denoted by a₀, a ratio of the radius of the circular light blocking portion to the radius of the circular aperture is defined as β (≡a₀/a).

Although the dynamic aperture according to the preceding embodiments has been basically described based on a circular aperture (β=0), when an annular aperture, in which a diffraction effect is more efficiently controlled, is applied, it is possible to reduce a diffraction Airy radius determined by diffraction at the same aperture size. Accordingly, a DOF range can be widened in the same optical system, and an MTF value in a high spatial frequency area can be increased.

Referring to FIG. 18, the basic structure of the optical system of the preceding embodiments is applied to the present embodiment, but an aperture shape of a dynamic aperture is an annular shape that blocks light in a portion of an intermediate area of the aperture, and thus, an area of a common light distribution area C1, through which light does not pass, is generated at a certain portion of a center of an optical axis. Accordingly, as shown in FIG. 17, the present embodiment has a characteristic in which an intermediate area of a bundle of light passing through the dynamic aperture is emptied.

However, even in this case, in the case of having the same dynamic aperture size A_{dl} (i.e., when A_{dl}=2a and β=0), a size of a partial exit pupil 51 at an observer pupil position determined geometrically or a size PD_{eye} of a convergence area of an image point of a virtual image determined by the partial exit pupil 51 may remain the same. However, when a dynamic aperture has an annular shape, a diffraction Airy radius can be decreased in a spatial frequency area of a high frequency, thereby improving optical characteristics. It is noted that, in an annular dynamic aperture, a condition at which a diffraction Airy radius is equal to a geometrical blur radius is changed and thus depending on the designed DOF range, the optimum condition or optimum range of the aperture is different from those of the general aperture of the preceding embodiments.

FIG. 18 illustrates a shape of the annular dynamic aperture when the dynamic aperture according to the present embodiment is viewed on the plane (X-Y plane) perpendicular to the optical axis. When the size A_{dl} of the dynamic aperture is given to be the same size A_{dl} as the dynamic aperture of the preceding embodiments, an area, through which light does not pass, is present in a certain area of a central area of the aperture. A defined ratio a₀/a of a blocked portion size to a dynamic size is important, and the present invention will be described by defining the defined ratio a₀/a as β.

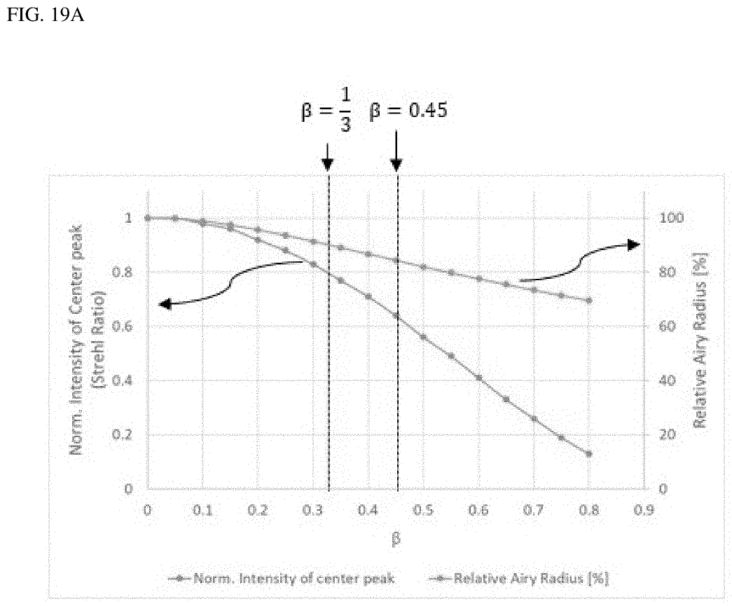

FIGS. 19A and 19B are graphs showing changes in main optical characteristics at an eye pupil position according to β.

A case in which β is 0 corresponds to a general dynamic aperture condition of the preceding embodiments, and as β is increased, a diffraction Airy radius is decreased. As a result, there is an advantage in that a DOF range is increased at the same size PD_{eye} of a convergence area of a virtual image. However, there is a problem in that image quality is degraded due to a decrease in center peak value (Strehl ratio) of a point spread function (PSF) of an image point formed on a retina of an eyeball, and there is a problem in that an amount of light is decreased due to an increase in β at the same aperture size A_{dl}.

Regarding consideration of conditions for a best use range of β, when a decreased amount of light is within 20%, light loss is not a big problem in practical applications, and when a Strehl ratio of a PSF in consideration of user's visibility is greater than or equal to 0.8 (approximately based on a Rayleigh's quarter wave criterion), there is no problem.

β that satisfies the two conditions is 1/3. In this case, about 89% of light may be used as compared with a case in which β is 0, a user may not feel degradation in image quality with user's visibility, and a DOF range may be widened to be about 12.5% at the same size PD_{eye} of the convergence area at the image point of the virtual image. Therefore, when a β value of an annular aperture according to the present invention is applied to the present invention, a value of about 1/3 can be optimally applied to β, and the (3 value can be applied within 1/3 according to the importance of a DOF range and light amount adjustment.

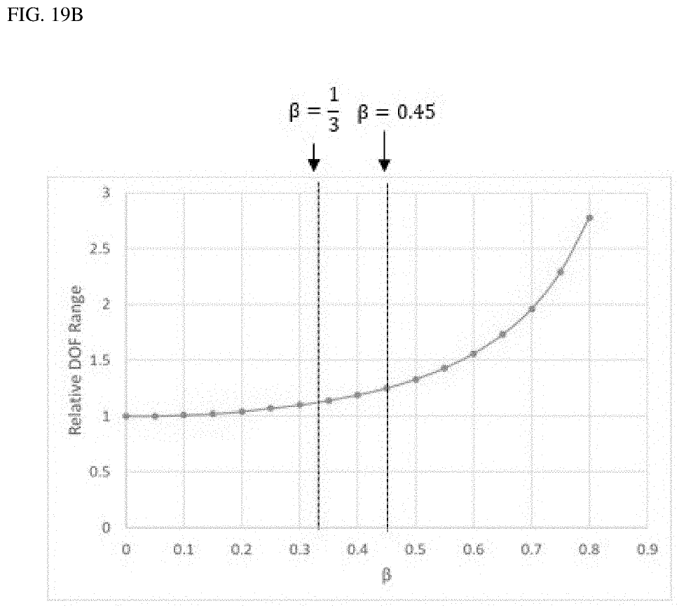

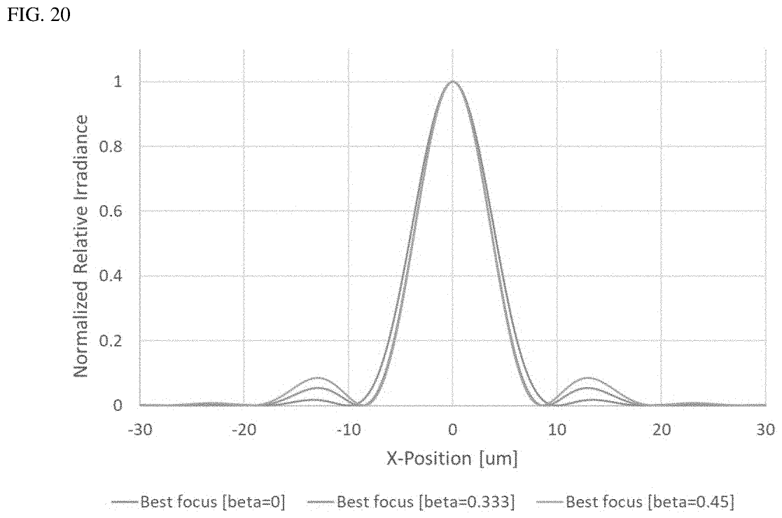

FIG. 20 is a graph showing a result of calculating normalized relative light distribution function values of a PSF on an eye retina according to three representative β values according to the sixth embodiment of the present invention. FIG. 21 is a graph comparing MTF curves and DOFs of annular apertures (β=1/3 and β=0.45) and a circular aperture (β=0) in dynamic apertures according to the sixth embodiment of the present invention.

A use range of β according to MTF characteristics according to a spatial frequency for comprehensively determining optical characteristics of a virtual image will be described as follows with reference to FIGS. 20 and 21.

FIG. 20 shows the result of calculating the normalized relative light distribution function values of the PSF according to three representative β values. As a β value is increased, as described above, a diffraction Airy radius is decreased, but an amount of light of an adjacent peak is relatively increased as compared with a central peak of the PSF, thereby resulting in a problem in that an MTF value is decreased at a spatial frequency in an intermediate area.

It is appropriate that an β value in consideration of an MTF according to a spatial frequency is set to a maximum β value at which characteristics, in which an MTF value is monotonically decreased as a spatial frequency is increased, are exhibited. A β value that satisfies this is 0.45. In this case, an amount of light is about 80% as compared with a case in which a β value is zero, and a Strehl ratio of a PSF is decreased to 0.64, and thus, some deterioration in image quality is felt as compared with the circular dynamic aperture (β=0). However, this is a condition applicable when considering a DOF range and a spatial frequency of a high frequency (at which a virtual image with increased resolution is provided).

Therefore, in the annular dynamic aperture according to the present invention, it is appropriate that β is within 1/3, but when visible spatial resolution or a DOF range becomes more important, β can extend to 0.45.

FIG. 21 shows MTF values at a normalized spatial frequency (cut-off spatial frequency is expressed as one) of the above-mentioned representative θ values (0, 1/3, 0.45). In the same dynamic aperture size, the DOF range is expanded by 12% and 25%, respectively, in the case where the β value is 1/3 and 0.45 compared to the case where the β value is 0. In addition, MTF values having an expanded DOF range when β values are 1/3 and 0.45 are compared with MTF values having the same expanded DOF range with a reduced dynamic aperture when β values are 0. As a result, it can be confirmed that, as β is increased, an MTF value of a spatial frequency less than or equal to an intermediate frequency is decreased but an MTF value of a high frequency area is increased as compared with the case in which the β value is zero.

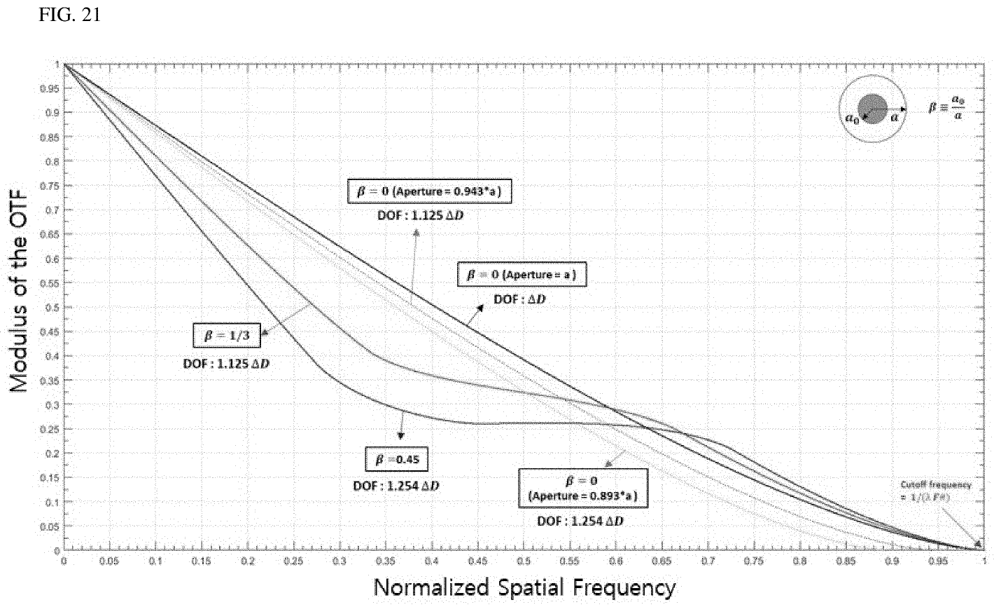

FIG. 22 is a view illustrating a configuration for adjusting a DOF range according to a seventh embodiment of the present invention. An application embodiment related to an adjustment of a DOF range in consideration of a necessary resolution of a virtual image will be described as follows with reference to FIG. 22.

A control system 60 may adjust an aperture size of a dynamic aperture adjustment element 30 to be widened so as to decrease a DOF range at a best virtual image position set according to a type of virtual image and to provide an image with increased resolution.

A size PD_{eye} of a convergence area at an eye pupil position should be decreased so as to widen a DOF range, but as the size PD_{eye} of the convergence area of an image point of a virtual image is decreased, a diffraction effect is increased, thereby reducing spatial resolution that may be provided by an optical system. Visible maximum spatial resolution is determined according to a resolution of a display and an FOV used in an optical system (see FIG. 4), but the maximum resolution may be further limited by a diffraction effect. As a result, it is difficult to properly view a detailed pattern (image with a text or a fine pattern).

A size PD_{eye} of a convergence area of an image point of a virtual image at an eye pupil position and a diffraction Airy radius satisfy Formula below.

$$Airy Radius = 1.22 λ \frac{{d}_{eye}}{{PD}_{eye}} \qquad ( Formula 3 )$$

Here, λ refers to a wavelength, and d_{eye} refers to a distance between an eye lens and a retina. In this case, a wavelength λ and an effective axial eye length d_{eye} of an eyeball used for calculating in embodiments of the present invention are 0.587 μm and 16.535 mm.

According to the present embodiment, when a high definition virtual image with many fine patterns is provided or a virtual image for mainly expressing a two-dimensional image such as a text is provided according to a type of virtual image, in the preceding embodiments, a DOF range is automatically decreased by the control system 60 or decreased by a user (that is, a size PD_{eye} of a convergence area of an image point of a virtual image is adjusted to be increased), thereby allowing the user to conveniently view a virtual image requiring high resolution.

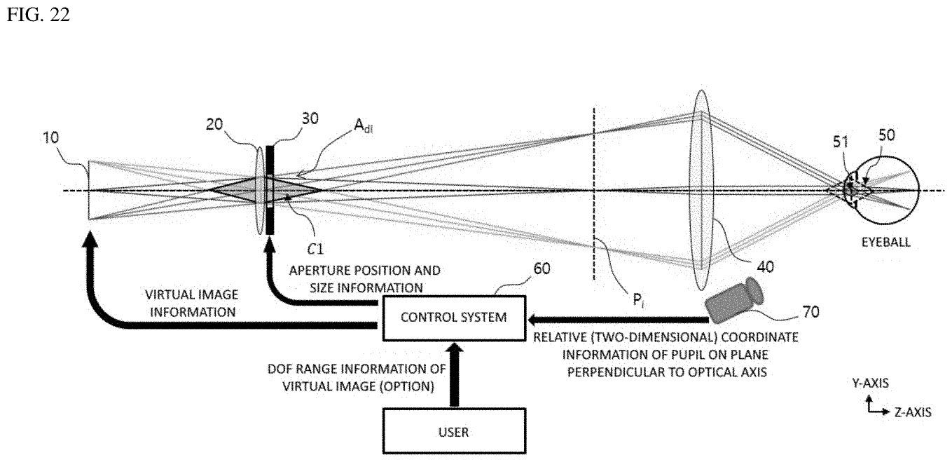

FIGS. 23A to 23C are a table and graphs showing a result of mathematically calculating a relationship between main variables for determining a DOF range according to the seventh embodiment of the present invention.

A specific embodiment of a DOF range adjustment and a spatial resolution adjustment will be described with reference to FIGS. 23A to 23C.

For example, when a DOF range is one diopter, a first optimal size PD_{eye1} of a convergence area of an image point of a virtual image is 1.693 mm, and when the DOF range is three diopters, a second optimal size PD_{eye2} of a convergence area of an image point of a virtual image is 0.9776 mm.

The size PD_{eye1} of the convergence area of the image point of the first virtual image at an eye pupil position is proportional to a size A_{dl} of a dynamic aperture of a dynamic aperture adjustment element disposed adjacent to a first lens, which is determined according to a ratio of Dₒ:Dₑ of an optical system. In the example of FIG. 2, when Dₒ:Dₑ is 3:1, the size A_{dl} of the dynamic aperture is 3×PD_{eye1}.

Therefore, in the case of one diopter, the size A_{dl} of the dynamic aperture is 5.08 mm, and in the case of three diopters, the size A_{dl} of the dynamic aperture is 2.933 mm. In this case, when an ideal diffraction limit (Airy radius) is calculated by applying an equation of Formula 3, the ideal diffraction limit is increased from 7 μm at one diopter to 12.12 μm at three diopters.

From the above results, when the DOF range is decreased from three diopters to one diopter, it is possible to implement a system which has increased brightness as well as increased maximum spatial resolution (which corresponds to a Rayleigh criterion and is a maximum spatial resolution at which two adjacent pixels are distinguishable from each other in consideration of diffraction).

In the above case, the DOF range of one diopter is three times brighter than the case of three diopter (as shown in Formula 1, a DOF range is inversely proportional to a square of a convergence area), and as a diffraction effect is decreased, maximum spatial resolution is increased by about 1.72 times.

In addition, even though a spatial frequency actually used in consideration of a resolution of a display and an FOV of a designed optical system uses a smaller area, an increase in maximum spatial resolution gives an effect of increasing an MTF value at a corresponding spatial frequency, thereby providing a higher contrast ratio of a virtual image to implement a clearer image.

A dynamic aperture size adjustment according to the seventh embodiment of the present invention will be described in detail as follows.

When a DOF range is determined, a dynamic aperture size is determined in a condition for imparting a necessary size PD_{eye} of a convergence area of an image point of a virtual image at an eye pupil position. A size A_{dl} of a dynamic aperture and the size PD_{eye} of the convergence area of the image point of the virtual image are in a proportional relationship and are determined according to a ratio of Dₒ:Dₑ of an optical system. Specifically, a relationship between the size A_{dl} of the dynamic aperture and the size PD_{eye} of the convergence area satisfies Formula 4 below.

$${A}_{dl} = \frac{{D}_{o}}{{D}_{e}} P {D}_{eye} \qquad ( Formula 4 )$$

Therefore, when an optical system providing virtual image is determined, the size A_{dl} of the dynamic aperture according to the size PD_{eye} of the convergence area of the image point of the virtual image, which is required for each DOF range to be applied, may be recorded in an internal look-up table, or a simple formula calculation may be applied.

For a change of the size A_{dl} of the dynamic aperture, when a user manually sets a DOF range, the control system 60 may change the size A_{dl} of the dynamic aperture through the dynamic aperture adjustment element 30.

In another embodiment, according to a type of content used by a user (when a wide DOF range is required or when a high resolution image as in a text is required at a specific distance), the control system 60 may automatically adjust the size A_{dl} of the dynamic aperture by selecting a necessary DOF range according to the type of content.

The dynamic aperture adjustment element 30 is a device which is disposed adjacent to a first lens (disposed in front or rear of the first lens) and adjusts an area of light of a virtual image, which passes through the first lens, according to the information of the dynamic aperture size A_{dl} received from the control system.

The dynamic aperture adjustment element 30 should adjust a position and size of an area, through which light passes, according to an electrical signal. Specifically, an LCD may be used, and among elements suitable to be applicable as an optical shutter, a ferroelectric liquid crystal (FLC) element capable of being operated at a high speed may be easy to use. In addition, other elements capable of adjusting a size and position of a transmission area thereof according to an electrical signal may be used as a dynamic aperture of the present invention.

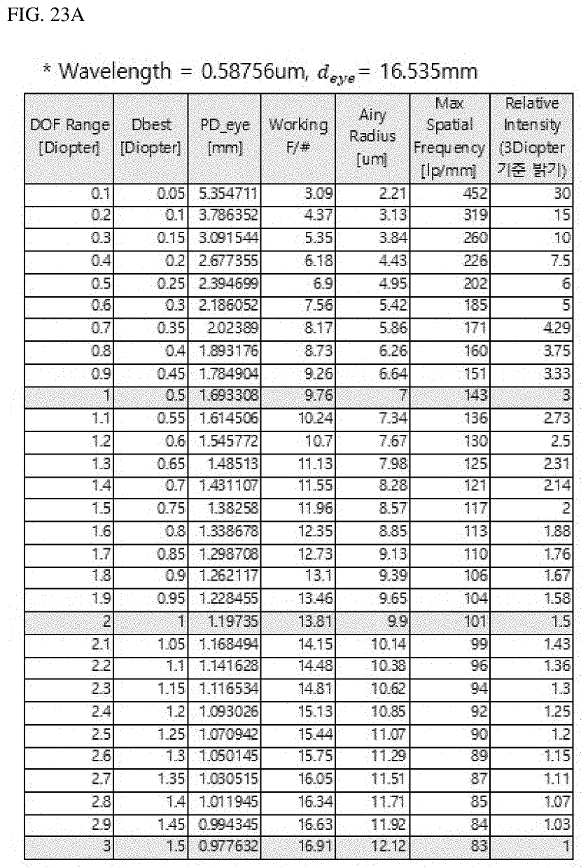

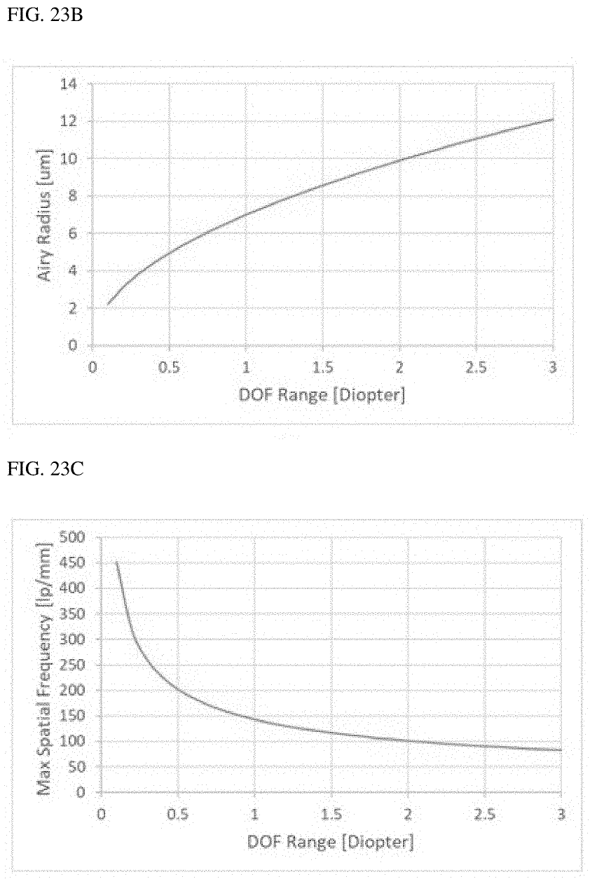

FIG. 24A is a cross-sectional side view illustrating a configuration for changing a best position of a virtual image by adjusting a display position according to an eighth embodiment of the present invention.

Since FIG. 24A illustrates the same structure as a basic optical system of the present invention shown in FIG. 1, descriptions of a basic structure will be omitted, and a basic principle of changing a best position D_{best} of a virtual image will be described with additional reference to FIG. 16. Descriptions of a dynamic aperture adjustment element 30 will be also omitted in FIG. 24A.

Referring to FIG. 24A, a display position adjustment element 80 (not shown) is provided to adjust a distance between a position of a display 10 and a first lens 20. A control system 60 (not shown) may control the display position adjustment element 80 to adjust a best virtual image position according to a set best virtual image position.

Virtual image information generated by the display 10 forms an intermediate image between the first lens 20 and a main optics lens 40, and when an intermediate image formation position from the main optics lens is the same as that of a focal distance of the main optics lens, a focus adjustment distance of an eye spaced apart from the main optics lens by an eye relief becomes an infinite distance (zero diopters).

When D_{obj0} denotes a distance from the main optics lens to a reference intermediate image formation position I₀ at which an infinite distance virtual image is provided to an observer, the intermediate image formation position for an infinite distance is determined according to a focal distance of the first lens 20 and a distance between the display 10 and the first lens 20 through a lens equation. Accordingly, a distance D_{md0} between a reference display position P₀ and the first lens is determined.

When the determined reference display position P₀ is changed to a position P₁ close to the first lens 20 (i.e., when a condition of D_{md1}<_{Dmd0} is satisfied), the reference intermediate image formation position is changed from I₀ to I₁, and thus, a distance to the main optics lens 40 is decreased. As shown in the drawing, a condition of D_{obj1}<D_{obj0} is satisfied.

In this case, I₁ is at a distance that is shorter than the focal distance of the main optics lens, which becomes a condition in which a virtual image is generated, and as a distance of the position I₁ from a reference position is increased, a position of a virtual image approaches to the main optics lens 40. The position of the virtual image according to the intermediate image formation position is the best position D_{best} of the virtual image viewed from an eye.

Therefore, the display position P₀ is adjusted to the position P₁ so as to be close to the first lens 20 spaced apart from the reference position by a predetermined distance, thereby changing the best position D_{best} of the virtual image.

FIG. 24B shows cross-sectional side views illustrating a configuration for changing a best position of a virtual image by adjusting a focus of a first lens according to another embodiment of the eighth embodiment of the present invention.

In FIG. 24A, the display position is adjusted, but in FIG. 24B, when the first lens is a lens having an adjustable focus, a basic principle of changing a best position D_{best} of a virtual image will be described.

Referring to FIG. 24B, a display 10 and a first lens 20 having an adjustable focal distance are provided, and a control system 60 (not shown) for controlling the first lens 20 may change the focal distance of the first lens 20 according to a set best virtual image position to adjust a best virtual image position.

Virtual image information generated by the display 10 forms an intermediate image between the first lens 20 and a main optics lens 40, and when an intermediate image formation position from the main optics lens is the same as that of a focal distance of the main optics lens, a focus adjustment distance of an eye spaced apart from the main optics lens by an eye relief becomes an infinite distance (zero diopters).

When D_{obj0} denotes a distance from the main optics lens to a reference intermediate image formation position I₀ at which an infinite distance virtual image is provided to an observer, the intermediate image formation position for an infinite distance is determined according to the focal distance of the first lens 20 and a distance between the display 10 and the first lens 20 through a lens equation. Accordingly, when a distance D_{md0} between a display position and the first lens is determined, the intermediate image formation position is determined according to the focal distance of the first lens.

At the determined distance between the display position and the first lens 20, the focal distance of the first lens may be adjusted to f_{L0} to adjust the intermediate image formation position to be I₀. In order to change the intermediate image formation position to I₁ close to the main optics lens 40, a focal distance should be changed to be longer as compared with the previous case. Such a relationship may be calculated using a lens equation. In this case, I₁ is at a distance that is shorter than the focal distance of the main optics lens, which becomes a condition in which a virtual image is generated, and as a distance of the position I₁from a reference position I₀ is increased, a position of a virtual image approaches the main optics lens 40. The position of the virtual image according to the intermediate image formation position is the best position D_{best} of the virtual image viewed from an eye.

Therefore, the best position of the virtual image may be changed by fixing the distance between the display position and the first lens and adjusting the focal distance of the first lens 20.

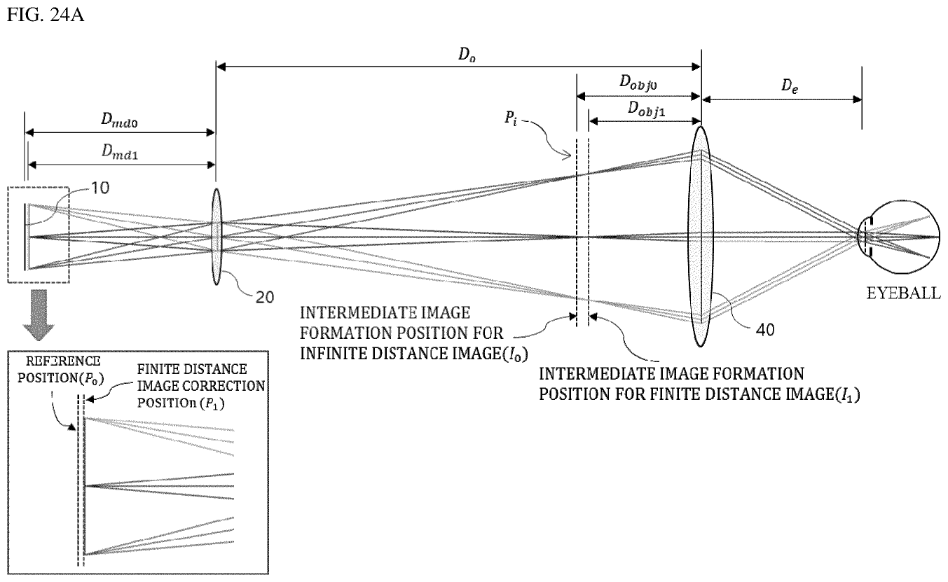

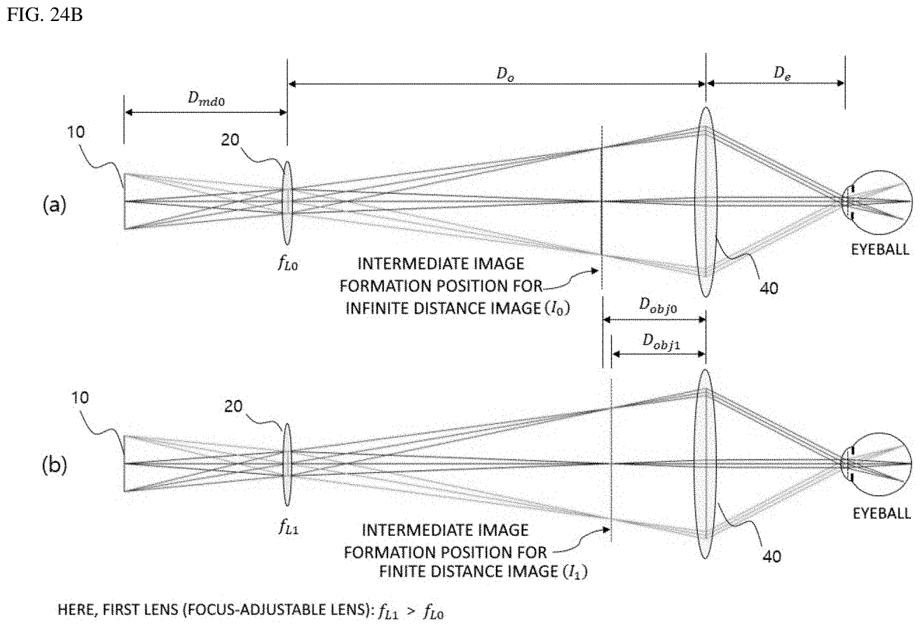

FIG. 25A is a graph showing a positional relationship of the display for adjusting a virtual image formation position according to the eighth embodiment of the present invention.

Referring to FIG. 25A, an absolute value for adjusting the display 10 from a reference position (infinite virtual image formation position) is changed according to a design of an optical system, and regarding a relationship therebetween, it can be seen that, on the basis of a diopter, a position of the display 10 for adjusting the virtual image formation position approaches the first lens 20 in linear proportion as the virtual image formation position in units of diopters increases.

As an example according to the embodiment of the present invention, FIG. 25A shows the positional relationship of the display for adjusting the virtual image formation position to 250 mm (four diopters) from an infinite position (zero diopters).

FIG. 25B is a graph showing a focal distance relationship of the first lens for adjusting a virtual image formation position according to another embodiment of the eighth embodiment of the present invention.

Referring to FIG. 25B, an absolute value for adjusting the focal distance of the first lens 20 (from an infinite virtual image formation position) is changed according to a design of an optical system, and regarding a relationship therebetween, it can be seen that the focal distance of the first lens 20 for adjusting the virtual image formation position is increased in linear proportion as the virtual image formation position in units of diopters increases.

As an example according to the embodiment of the present invention, FIG. 25B shows a relationship with the focal distance of the first lens 20 of adjusting the virtual image formation position to 250 mm (four diopters) from an infinite position (zero diopters).

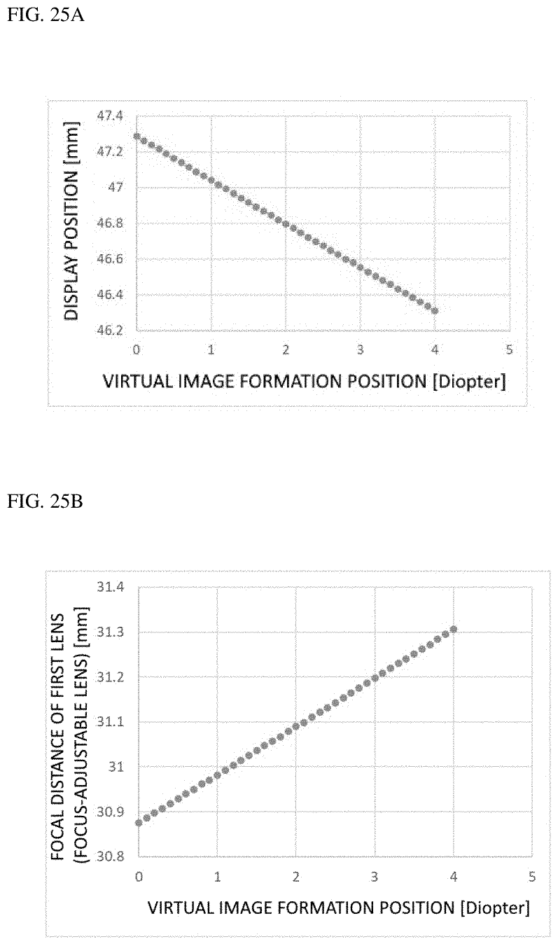

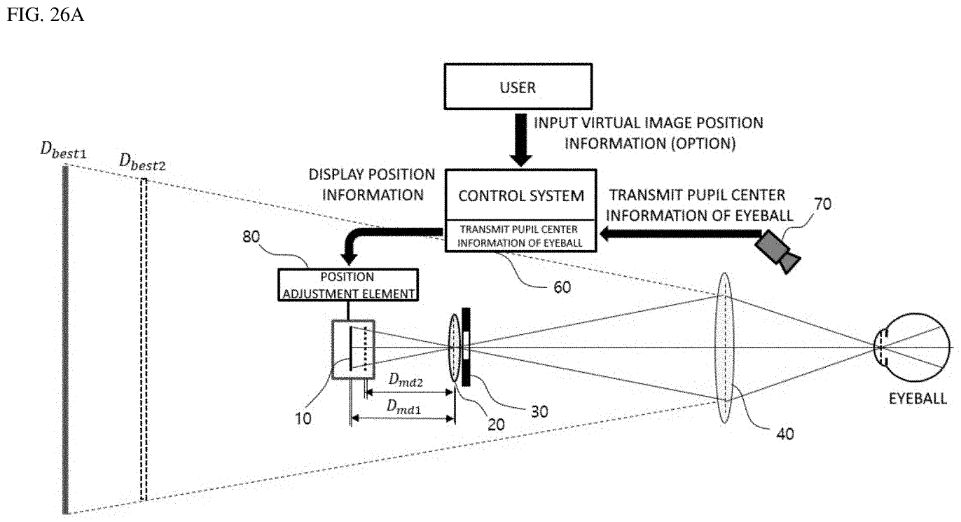

FIG. 26A is a cross-sectional side view illustrating a configuration for adjusting a best position of a virtual image from an eyeball by adjusting a display distance from the first lens according to the eighth embodiment of the present invention.

Referring to FIG. 26A, in the eighth embodiment of the present invention, a pupil tracking device 70 for tracking a focus adjustment position of an eye of an observer is further provided. The control system 60 may control the display position adjustment element 80 to form a best virtual image position close to a gaze depth position of an eye of an observer using pupil tracking information acquired by the pupil tracking device 70.

Alternatively, when a user manually inputs best position information of a virtual image, the control system 60 may transmit display adjustment position information corresponding to the best position information to the position adjustment element 80 for controlling a position of the display 10 and adjust the position of the display 10 through the position adjustment element 80, thereby adjusting a best virtual image formation position.

FIG. 26A illustrates a structure in which a distance from the first lens 20 to the display 10 is adjusted from D_{md1} to D_{md2} to adjust the best position of the virtual image from D_{best1} to D_{best2} from the eye according to the eighth embodiment of the present invention.

FIG. 26B is a cross-sectional side view illustrating a configuration for adjusting a best position of a virtual image from an eye by adjusting a focal distance of the first lens according to another embodiment of the eighth embodiment of the present invention.

Referring to FIG. 26B, in another embodiment of the eighth embodiment of the present invention, a pupil tracking device 70 for tracking a focus adjustment position of an eye of an observer is further provided. The control system 60 may control the focal distance of the first lens to form a best virtual image position close to a gaze depth position of the eye of the observer using pupil tracking information acquired by the pupil tracking device 70.

Alternatively, when a user manually inputs best position information of a virtual image, the control system 60 may transmit focal distance information corresponding to the best position information to the first lens, thereby adjusting a best virtual image formation position.

FIG. 26B illustrates a structure in which the focal distance of the first lens 20 is adjusted from f_{L1} to f_{L2} to adjust the best position of the virtual image from D_{best1} to D_{best2} from an eyeball according to another embodiment of the eighth embodiment of the present invention. In this case, when f_{L1} is shorter than f_{L2}, a first virtual image best position d_{best1} is formed farther away from the eyeball than a second virtual image best position D_{best2}.

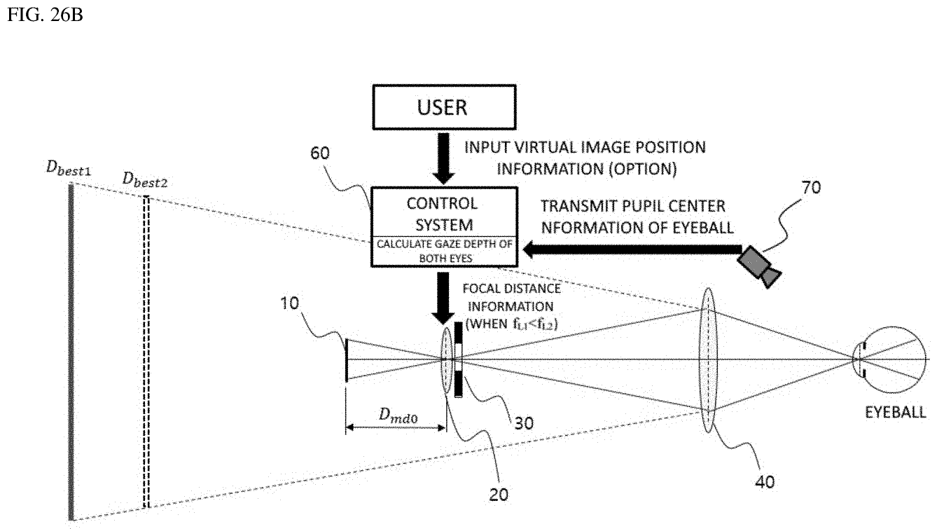

FIG. 27 is a cross-sectional side view illustrating pupil tracking devices for tracking the pupil center information of both eyes of an observer and a control system for receiving the pupil center information and calculating a gaze depth of both eyes to adjust a position at which a virtual image is formed in FIGS. 26A and 26B.

Referring to FIG. 27, two pupil tracking devices 71 and 72 are provided and track convergence position information of both eyes of an observer. A control system 60 may control a display position adjustment element 80 to form a best virtual image position close to a gaze convergence depth of both eyes of the observer.

In addition, referring to FIG. 27, the two pupil tracking devices 71 and 72 are provided and track convergence position information of both eyes of the observer. The control system 60 may control a focal distance of a first lens according to a control signal to form the best virtual image position close to the gaze convergence depth of both eyes of the observer.

When one pupil position tracking device 70 is used in the preceding embodiments, and when only position information of a pupil center of a single eye is used, it may be difficult to determine a gaze depth of both eyes of an observer. In order to overcome the difficulty, as embodiments of the present invention, the pupil tracking devices 71 and 72, which apply an algorithm for tracking the pupil orientation direction of both eyes of the observer, may be used to calculate an distance at which both eyes converge, and the calculated distance may be determined as a best focal distance of an observer's gaze, thereby providing information about best virtual image formation position to the control system 60.

Meanwhile, the display position adjustment element of FIG. 26A may be a piezoelectric element capable of performing precise position control, a voice coil motor (VCM), or an LCD in which a refractive index thereof is changed according to an electrical signal to adjust an effective distance between the display and the first lens.

Meanwhile, a type of the first lens capable of controlling a focal distance adjustment according to a control signal from the control system of FIG. 26B is a focus tunable lens, a polymer lens, a liquid lens, a liquid crystal lens, or a lens of which a refractive index for each position of the lens is changed according to an electrical signal.

In the previous embodiments, it has been described that a distance between a display and a first lens (fixed focal distance lens) can be controlled by a control system in order to change a best formation position of a virtual image, and apart from this, a focal distance of a first lens can be controlled while maintaining a distance between a fixed display and the first lens (variable focal distance lens). Although it will not be described in detail in the present invention, two such technologies of the present invention can be driven in a time division manner to implement two or more best formation positions of a virtual image within one frame. Thus, it is possible to effectively widen a DOF range of a virtual image. On the other hand, in order to widen a DOF range at one best formation position of a virtual image, a size of an exit pupil at an eye pupil position should be decreased, which causes loss of an amount of light entering an eye pupil and a decrease in resolution of a virtual image due to an increase in diffraction limit. As an alternative capable of overcoming such disadvantages, forming two or more best formation positions of a virtual image in a time division manner has an advantage.

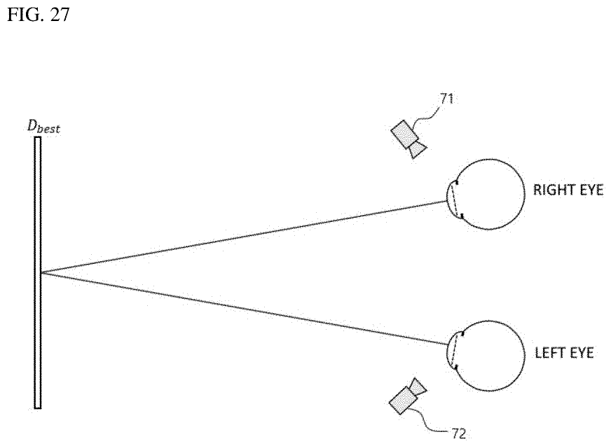

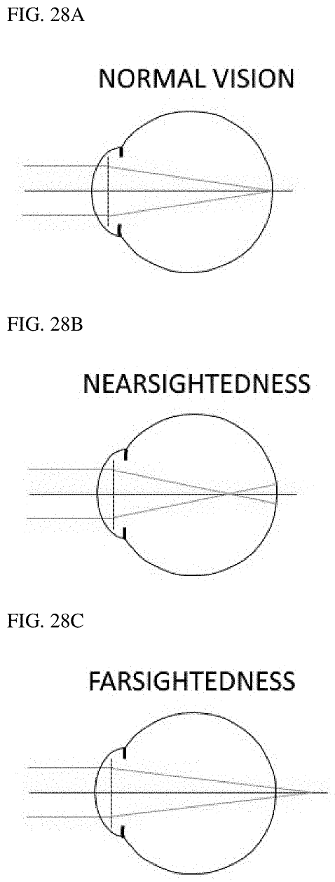

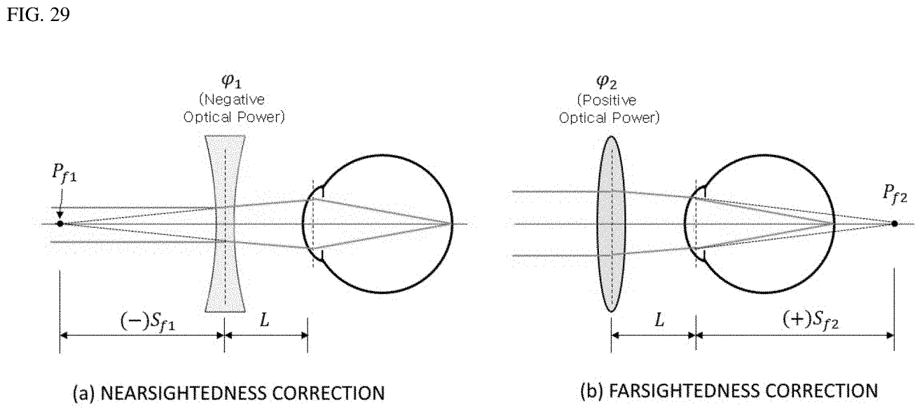

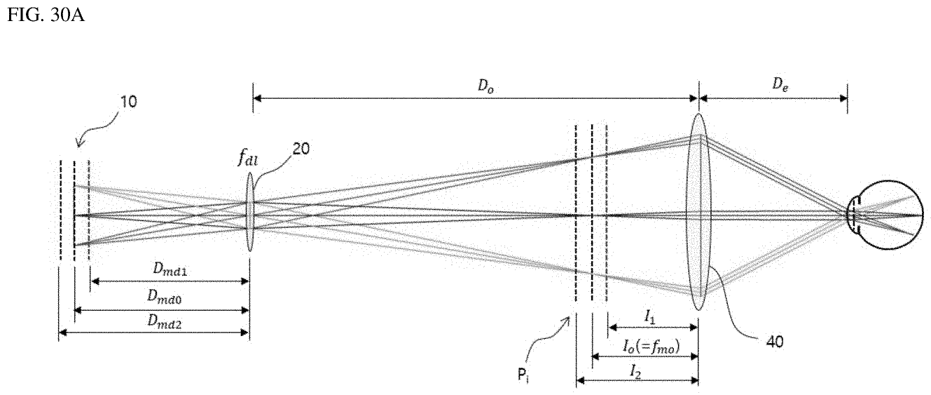

FIGS. 28A to 28C show cross-sectional side views illustrating a refractive power error of an eyeball according to normal vision and nearsightedness or farsightedness for describing a principle of correcting vision of an abnormal vision (near-sighted or far-sighted) observer according to a ninth embodiment of the present invention. FIG. 29 shows cross-sectional side views illustrating structures for showing a principle of a correction lens for an abnormal vision (near-sighted or far-sighted) eyeball. FIGS. 30A and 30B are cross-sectional side views illustrating configurations for correcting vision of an abnormal vision observer according to the ninth embodiment of the present invention.

Referring to FIGS. 28, 29, and 30A, for an abnormal vision observer with nearsightedness or farsightedness, a vision correction value is input to a control system 60 (not shown) to correct a position of a display 10 corresponding to a set best virtual image position, thereby providing a best virtual image position to the abnormal vision observer without wearing vision correction glasses.

Referring to FIGS. 28, 29, and 30B, for an abnormal vision observer with nearsightedness or farsightedness, a vision correction value is input to the control system 60 (not shown) to correct a focal distance of a first lens 20 corresponding to a set best virtual image position, thereby providing a best virtual image position to the abnormal vision observer without wearing vision correction glasses.

An adjustment of a best position of a virtual image in the preceding embodiments has been described based on an observer having a normal vision eyeball, but actually, many observers do not have normal vision without vision correction glasses (lenses). In addition, when a near-eye display device of the present invention is used by wearing vision correction glasses, there is inconvenience in using the device, and also, when sufficient eye relief is not secured according to a design of an optical system, it is difficult to see the optimal virtual image.

In the present embodiment, in order to solve such problems, the device of the present invention is used without vision correction glasses, thereby allowing an observer having an abnormal vision eyeball such as a near-sighted or far-sighted eyeball to properly view a virtual image.

FIGS. 28A to 28C illustrate a difference between a normal vision eyeball and an abnormal vision eyeball such as a near-sighted or far-sighted eyeball. Regarding a difference between normal vision and nearsightedness or farsightedness, in a relaxed accommodation state, an infinite distance object may be properly focused on a retina in the case of the normal vision but may not be focused on the retina in the case of the nearsightedness or farsightedness.

In the case of nearsightedness, an image is formed in front of a retina (when a focal distance of an eye lens is shorter than an average or an axial eye length is longer than the average), and on the contrary, in the case of farsightedness, an image is formed in rear of a retina (when a focal distance of an eye lens is longer than an average or an axial eye length is shorter than the average), which are called a refractive power error of an eyeball and can be corrected using a vision correction lens.

Referring to FIG. 29, nearsightedness corresponds to a case in which a focal distance of an eye lens at the time of maximum relaxation is too short with respect to an object at an infinite distance (or when optical power is too high). By using a lens (concave lens) with negative optical power as a correction lens, a virtual image of the object at the infinite distance is allowed to be placed at a predetermined distance S_{f1} in front of the correction lens to allow light of the object at the infinite distance to diverge at an eye lens position by as much as vision correction value, thereby being properly focused on a retina of a near-sighted user.

Farsightedness corresponds to a case in which a focal distance of an eye lens at the time of maximum relaxation is too long with respect to an object at an infinite distance (or when optical power is too low). By using a lens (convex lens) with positive optical power as a correction lens, a real image of the object at the infinite distance is allowed to be placed at a predetermined distance S_{f2} in rear of the correction lens to allow light of the object at the infinite distance to converge at an eye lens position by as much as vision correction value, thereby being properly focused on a retina of a far-sighted user.

Referring to FIG. 30A, in order to apply a principle of correcting an abnormal eye with nearsightedness or farsightedness briefly described above, vision of an observer is corrected based on basic setting (that is, d_{best}=zero diopters) for providing an infinite distance object position.

Specifically, when a distance between the display 10 and the first lens 20 is adjusted to D_{md0}) to adjust an intermediate virtual image formation position to be spaced apart from a main optics lens by a focal distance of the lens in front of the main optics lens (condition of I₀=fₘₒ), a normal vision user at a position spaced apart from an optical system by an eye relief Dₑ can observe a virtual image at an infinite position. Such positions become a reference display position D_{md0}) and an intermediate virtual image formation position I₀, at which a virtual image is provided to a normal vision eye.

In order to provide an infinite distance virtual image to a near-sighted user, a virtual image position I₁ is formed closer to a main optics lens 40 than a virtual image reference position I₀ of normal vision to allow light entering an eye lens to be properly focused on a retina with the same principle of correction glasses for a near-sighted eye described above so that the near-sighted user can view the infinite distance virtual image properly. In order to implement this, the position of the display 10 is adjusted to D_{md1} which is closer to the first lens 20 than a position of the normal vision.

In order to provide an infinite distance virtual image to a far-sighted user, a virtual image position I₂ is formed farther away from the main optics lens 40 than the virtual image reference position I₀ of the normal vision to allow light entering an eye lens to be properly focused on a retina as the same principle of correction glasses for a far-sighted eye described above so that the far-sighted user can view the infinite distance virtual image properly. In order to implement this, the position of the display 10 may be adjusted to D_{md2}, which is farther away from the first lens 20 than a position of the normal vision.

In the above, unlike a normal vision eye, it has been described that a reference position of an infinite distance virtual image is corrected based on a reference position of a display with respect to a near-sighted eye and a fart-sighted eye. When D_{best} approaches an infinite distance based on such a position, a display position can be changed by reflecting a virtual image formation position from a reference display position of each user.

The control system 60 (not shown) may transmit display position information according to a best position of a virtual image to a position control element by making reference to a stored data table with respect to a reference display position (reference position with respect to an infinite distance object) for each corrected vision reflecting the above contents.

Referring to FIG. 30B, instead of adjusting a distance between the display 10 and the first lens 20 shown in FIG. 30A as described above, the focal distance of the first lens 20 is adjusted to correct vision of an observer.

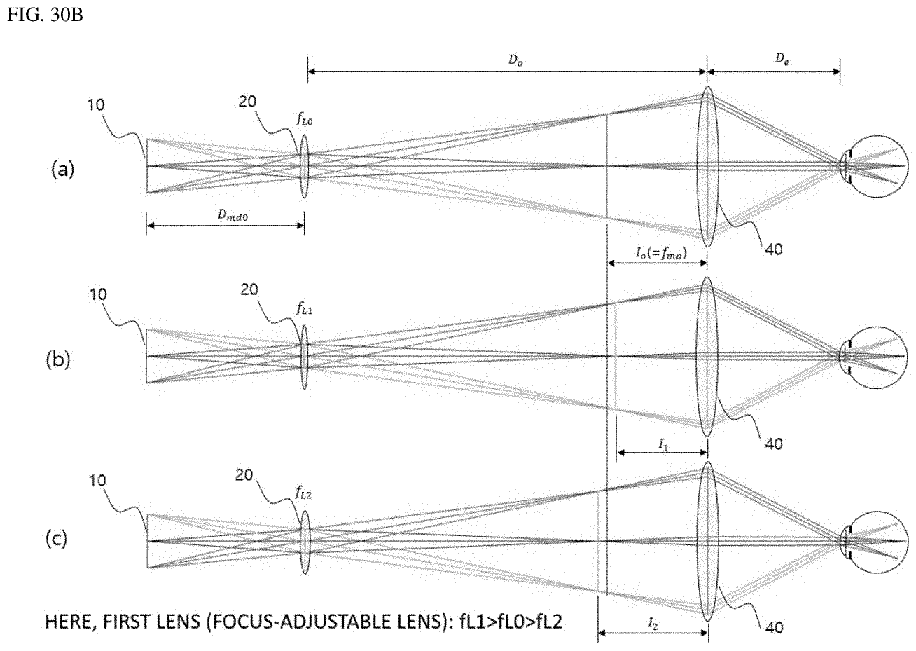

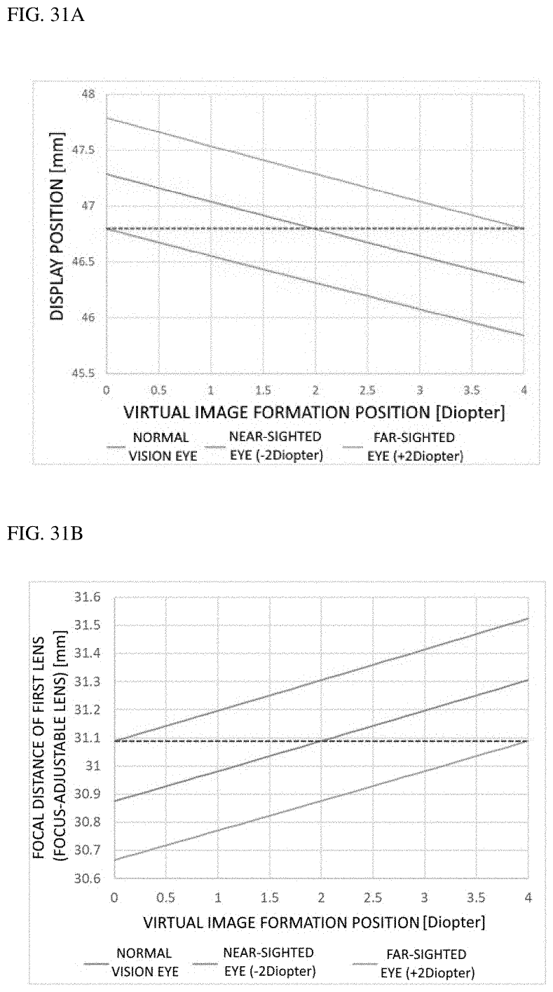

FIG. 31A is a graph showing the relationship between a specific display position adjustment and a best virtual image formation position (based on a diopter unit) according to the ninth embodiment of the present invention.

Referring to FIG. 31A, display positions, at which the same best virtual image is provided to users of a normal vision eye, a near-sighted eye (−2 diopters), and a far-sighted eye (+2 diopters), are compared. Among these, on a dotted line, a display position corresponding to 2D (0.5 m) of the normal vision eye, at which a best image is provided, is the same as a position corresponding to OD (infinite distance) of the near-sighted eye at which a best image is provided and is the same as a position corresponding to 4D (0.25 m) of the far-sighted eye at which a best image is provided. This is a result of correcting vision of abnormal vision users by as much as corresponding values.

This is an embodiment in which vision of the abnormal vision users is corrected with respect to a virtual image, and when the present invention is used as an augmented reality (AR) device in which an external real object needs to be viewed together with a virtual image, a separate vision correction of an abnormal vision user is required with respect to the external real object. When the present invention is used as the AR device, a method of correcting vision of a user with respect to an external real object will be described as a twelfth embodiment to be described below.

FIG. 31B is a graph showing the relationship between a focal distance adjustment of a first lens and a specific best virtual image formation position (based on a diopter unit) according to another embodiment of the ninth embodiment of the present invention.

Referring to FIG. 31B, focal distances of the first lens, at which the same best virtual image is provided to users of a normal vision eye, a near-sighted eye (−2 diopters), and a far-sighted eye (+2 diopters), are compared. Here, according to the focal distance of the first lens, the virtual image formation position of the normal vision eye, the near-sighted eye, and the far-sighted can be compared in the same manner as in a relationship of FIG. 31A.

This is an embodiment in which vision of abnormal vision users is corrected with respect to a virtual image, and when the present invention is used as an AR device in which an external real object needs to be viewed together with a virtual image, a separate vision correction of an abnormal vision user is required with respect to the external real object. When the present invention is used as the AR device, a method of correcting vision of a user with respect to an external real object will be described as the twelfth embodiment to be described below.

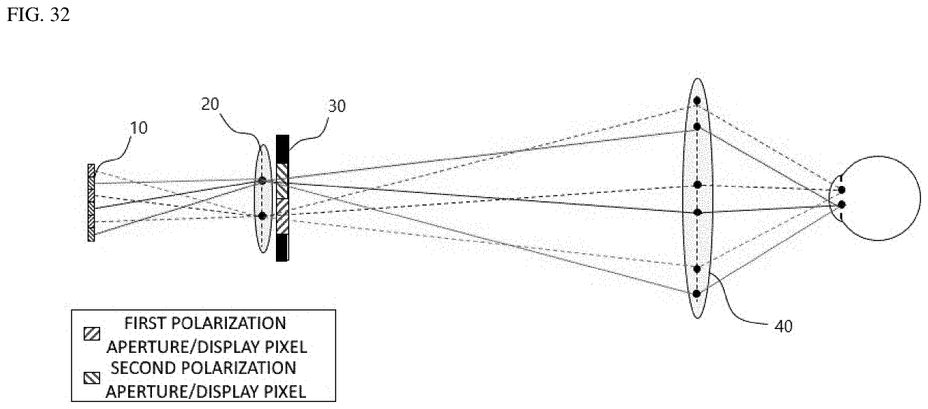

FIG. 32 is a cross-sectional side view for describing a dynamic aperture adjustment element to which a polarization aperture set is applied according to a tenth embodiment of the present invention.

Referring to FIG. 32, two parallax images adjacent to an eye pupil position are provided by applying two polarization-divided display pixels and two dynamic apertures having polarization directions orthogonal to each other.

Specifically, a display 10 includes a plurality of pixels, and adjacent pixels of each pixel provide a first virtual image having first polarization and a second virtual image having second polarization which is orthogonal to the first polarization. A dynamic aperture adjustment element 30 includes a polarization aperture set including a first aperture having the first polarization and a second aperture having the second polarization. Two virtual images of the display 10 may be transferred to an eye pupil position of an observer through the polarization aperture set of the dynamic aperture adjustment element 30 so that an exit pupil may be expanded. The first virtual image and the second virtual image may be parallax images.

In addition, the polarization aperture set of the dynamic aperture adjustment element 30 may have two or more horizontal positions, and apertures having different horizontal positions of the dynamic aperture adjustment element 30 may be sequentially operated in one frame virtual image according to a control signal from a control system 60 (not shown) to sequentially arrange two or more exit pupils, thereby enlarging a size of the exit pupil.

In addition, the control system 60 (not shown) may sequentially provide two or more parallax images to the display 10 in synchronization with a horizontal position change of the polarization aperture set of the dynamic aperture adjustment element 30, thereby arranging different parallax images at positions of the exit pupils.

Hereinafter, a method of using a polarization division will be described in more detail.

When some pixels of an element of the display 10 have the first polarization (circular polarization or linear polarization) and the remaining pixels thereof have the second polarization (circular polarization or linear polarization) orthogonal to the first polarization, and when the dynamic apertures include a first aperture having the same polarization direction as the first polarization and a second aperture having the same polarization direction as the second polarization, even if there is no time division, it is possible to provide two parallax images to an eye pupil of a user and also provide a virtual image in which a DOF range is wide and an exit pupil is expanded.

On the other hand, since an entire resolution of the display is divided in half, a virtual image passing through the first aperture and the second aperture of the dynamic apertures is formed to have decreased resolution. However, since currently available displays have a full HD resolution (1920×1080), even when resolution is divided in half for each parallax image, degradation in image is not a big problem, and when high definition displays with a resolution of 4K or more are developed in the future, an image with FHD resolution or more may be provided for each parallax image.

FIG. 32 illustrates an embodiment of the present invention in which two parallax images adjacent to an eye pupil position are provided by applying the two polarization-divided display pixels and the two dynamic apertures having the polarization directions orthogonal to each other. An optical path indicated by a solid line corresponds to a convergence point at the eye pupil position of the first parallax image having the first polarization, and an optical path indicated by a dotted line corresponds to a convergence point at the eye pupil position formed by the second parallax image having the second polarization.

Moreover, it is also possible to use a polarization division and a time division at the same time. For example, an embodiment in which two polarization aperture sets are applied may be used in combination with the preceding first to third embodiments. When the embodiments are used in combination, the number of parallax images in an exit pupil can be effectively increased while a DOF range is wide. For example, when a polarization division (two orthogonal polarization apertures used as one dynamic aperture set) and three dynamic aperture sets are sequentially driven within one frame in a time division manner, six parallax images can be provided.

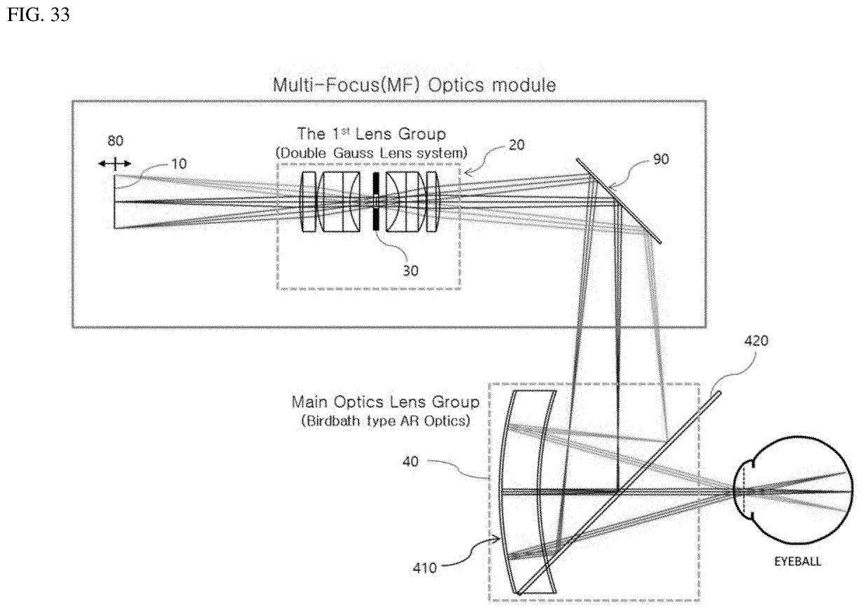

FIG. 33 is a cross-sectional side view illustrating a near-eye display device when being used as an AR device according to an eleventh embodiment of the present invention.

In the preceding embodiments, for convenience of description, an operating principle and a virtual image controlling method of the present invention have been described based on the first lens 20 and the main optics lens 40 expressed as thin lenses, but each lens may be used as a group of several lenses in order to actually apply the present invention.

In particular, when technology of the present invention is used as the AR device, since a position of a display 10 for providing a virtual image should not block an external viewing window, it is necessary to additionally use an optical path changing element such as a mirror or a beam splitter.

FIG. 33 illustrates a specific embodiment in which a concept of the present invention is applied to AR and illustrates a case in which a double Gauss lens system 20 is used instead of a first lens and in which a birdbath type AR optical system including a trans-reflective concave mirror 410 and a beam splitter 420 is used as a main optics lens 40. In addition, in order to effectively implement a compact near-eye display device, one reflective mirror 90 is used between the lens system 20 and the AR optical system.

A dynamic aperture adjustment element 30 may be disposed near a center position of the double Gauss Lens system. In addition, the position of the display 10 may be adjusted by a position adjustment element 80 in order to change a best virtual image formation position.

An AR structure according to the present invention may be mainly divided into two parts and may be divided into a multi-focus (MF) optics module and a basic AR optical system. As a specific operating method of the MF optics module, the operating method of the preceding embodiments may be applied, and light passing through the lens system 20 is reflected by the reflective mirror 90 to travel to the AR optical system. In the AR optical system, light reflected by the beam splitter 420 is reflected again by the trans-reflective concave mirror 410 to travel to an eye of a user. Although not shown in the drawing, as in the previous embodiments, a pupil tracking system may be additionally provided.

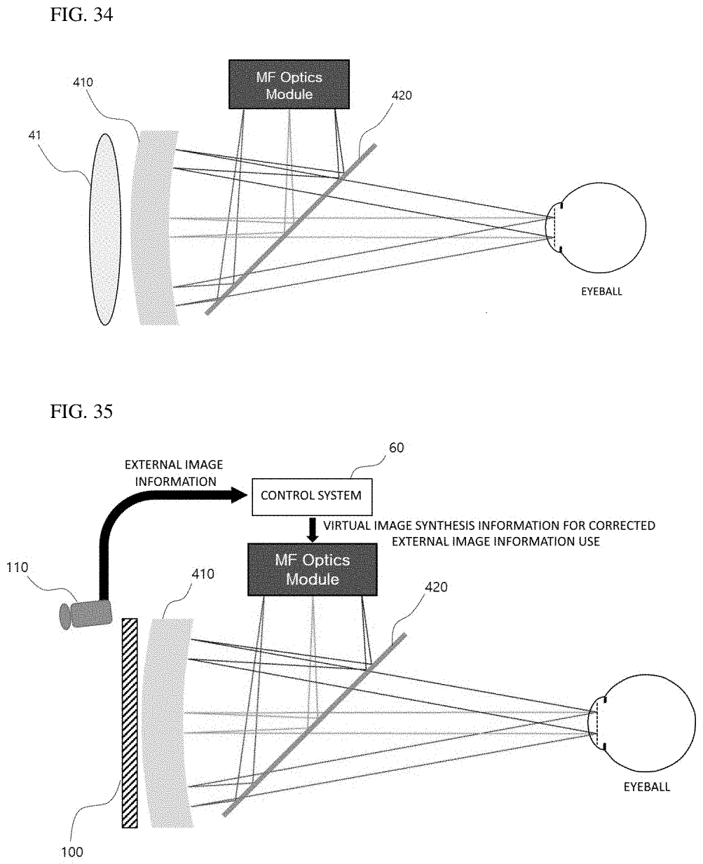

FIG. 34 is a cross-sectional side view illustrating a structure used as an AR device additionally provided with a vision correction lens according to a twelfth embodiment of the present invention.

In an MF Optics module, even when the visual acuity of a user is not normal vision (nearsightedness/farsightedness), the visual acuity of the user may be corrected by adjusting a display position, thereby providing a specific distance virtual image (see the preceding embodiments for detailed descriptions of vision correction).

However, when the present invention is applied as an AR device, it is necessary to properly view an external real object and a virtual image at the same time. To this end, a lens for correcting vision of a user may be additionally provided in front of an external viewing window of an AR optical system. When a user wears a vision correction lens and uses a device, since an eye relief is not sufficient, it may be difficult to observe a best optimal image. Such inconvenience can be solved through the above configuration.

Referring to FIG. 34, in the twelfth embodiment of the present invention, a vision correction lens 41 for an abnormal vision observer with nearsightedness or farsightedness may be optionally additionally provided on an outer surface of the external viewing window in the AR optical system. Meanwhile, as the vision correction lens, a detachable fixed lens or a vision correction lens designed for a user may be applied.

In addition, for the abnormal vision observer with nearsightedness or farsightedness, a vision correction value is input to a control system 60 (not shown) to correct a position of a display 10 or a focal distance of a first lens 20, which corresponds to a set best virtual image position, thereby providing a best observing position to the abnormal vision observer without wearing vision correction glasses.

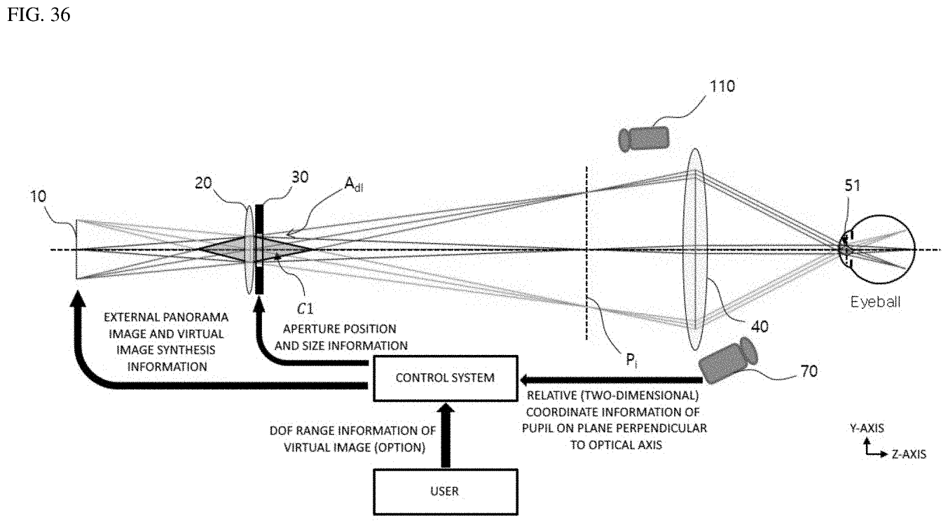

FIG. 35 illustrates a configuration including a shielding component and an external sight camera which are optionally applied in front of an external viewing window in an AR optical system according to a thirteenth embodiment of the present invention and is a cross-sectional side view of an optical system when being applied as a mixed reality (MR) or extended reality (XR) device. In this case, when the shielding component is optionally used, AR and MR/XR functions can be optionally implemented. Referring to FIG. 35, in the thirteenth embodiment of the present invention, a shielding film 100 may be optionally provided in front of the external viewing window in the AR optical system, and two external sight cameras 110 may be provided (wherein, in the drawing, for convenience, one external sight camera 110 is illustrated with respect to only one eye). External images captured by first and second external sight cameras 110 may be combined with a virtual image in a display 10 through a control system 60 (not shown) to be provided to both eyes of an observer.

In addition, the external images of the two external sight cameras 110 may be corrected in consideration of a corresponding eye pupil position of the observer to be provided to both eyes of the observer.

In addition, two observer pupil position tracking devices may also be provided. Information acquired by each pupil position tracking device may be transmitted to the control system 60 (not shown), and the control system 60 (not shown) may compare positions of both eyes of the observer with positions of two external sight cameras 110 to correct corresponding external images. In this case, a virtual image, in which a captured external image and a stored virtual image are combined with each other, may be provided to an observer.

In this case, in order to optionally apply an external sight shielding component positioned on an outer surface of the external viewing window, clip-type sunglasses or the like may be used as a shielding component, and sunglasses of which transmittance is adjustable according to an electrical signal may be used.

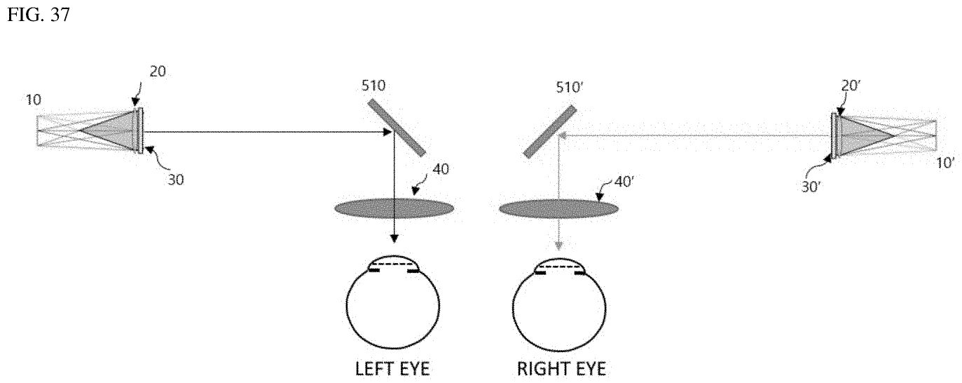

FIG. 36 illustrates a case in which an optical system is used as an MR or XR device according to a fourteenth embodiment of the present invention. In this case, in FIG. 8, an external sight camera is provided for each eyeball.

In order to implement a structure of an MR or XR-dedicated device using technology of the present invention, a virtual reality (VR) optical system structure, to which the preceding embodiments of FIGS. 5, 8 and 16 are applied, is used, and a camera for capturing an external view of each eye in both eyes is additionally provided.

In the embodiments of FIGS. 35 and 36, one external sight camera is applied per eye, and each camera is a camera configured to provide a DOF range to be provided in the present invention, or a camera system such a depth camera having an image processing function. In this case, an adjusted image for each eye of the camera corresponding to each eye is used as a parallax image for each eye. When a depth camera is used, a parallax image for each eye may be generated using only one camera.

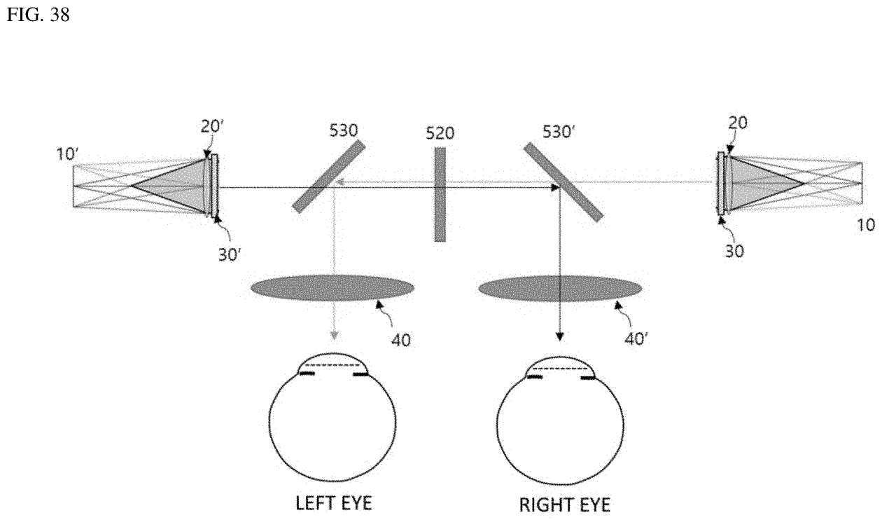

FIG. 37 illustrates a case in which an optical structure is applied to both eyes when being applied to VR, AR, MR, or XR according to another embodiment of the present invention, and mirrors 510 and 510′ may be additionally included.

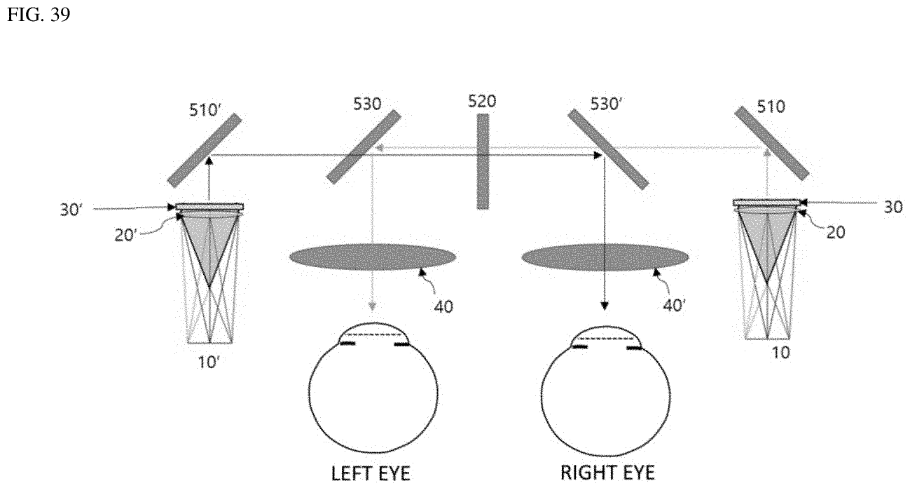

When compared with FIG. 37, FIGS. 38 and 39 are views for describing a volume of an entire optical system being decreased by using polarized light passing through a dynamic aperture and applying a polarization beam splitter and a half-wave retarder. For example, when light passing through a left dynamic aperture is P-polarized, the P-polarized light passing through the left dynamic aperture passes through a left polarization beam splitter 530, is S-polarized by passing through a half-wave retarder 520 in a next optical path, and is reflected by a right polarization beam splitter 530′ to travel to a right main lens 40′. The light enters a right eye of a user. When light passing through a right dynamic aperture is P-polarized, the P-polarized light passing through the right dynamic aperture passes through the right polarization beam splitter 530′, is S-polarized by passing through the half-wave retarder 520 in a next optical path, and is reflected by the left polarization beam splitter 530 to travel to a left main lens 40. The light enters a left eye of the user. By using such a structure, two optical systems share a space between two polarization beam splitters 530 and 530′, thereby reducing a volume of the entire optical system. By using polarization and a wave retarder as described above, it is possible to minimize light loss in a polarization beam splitter.

FIG. 39 shows a case in which a reflector 510 or 510′ is added between the dynamic aperture adjustment element 30 or 30′ and the polarization beam splitter 530 or 530′ in order to minimize the volume in FIG. 38.

The protected scope in the present field is not limited to the description and the expression of the embodiments explicitly described above. In addition, it is added again that the protected scope of the present invention is not limited by obvious changes or substitutions in the technical field to which the present invention belongs.

1. A near-eye display device comprising:
a display;
a first lens disposed in front of the display so as to be spaced apart from the display by a predetermined distance;
a dynamic aperture adjustment element disposed adjacent to the first lens to dynamically control an aperture size of the first lens and a horizontal position of the aperture on a plane perpendicular to an optical axis;
a main optics lens disposed to be spaced apart from the first lens by a predetermined distance; and
a control system configured to control the dynamic aperture adjustment element,
wherein an eye pupil of an observer is positioned in an exit pupil disposed to be spaced apart from the main optics lens by a predetermined distance, and
a size and a horizontal position of the exit pupil are determined according to the size and the horizontal position of the aperture of the dynamic aperture adjustment element that are adjusted according to a control signal from the control system.

2. The near-eye display device of claim 1, wherein the size of the aperture of the dynamic aperture adjustment element is adjusted such that the size of the exit pupil is within 2 mm that is smaller than a pupil size of the observer.

3. The near-eye display device of claim 1, wherein the dynamic aperture adjustment element is a liquid crystal device (LCD) or an electronic shutter, in which a size and a horizontal position of an aperture thereof are adjustable according to the control signal from the control system.

4. The near-eye display device of claim 1, wherein the dynamic aperture adjustment element has two or more horizontal positions of the apertures, and
the apertures at the horizontal positions of the dynamic aperture adjustment element are sequentially operated within one frame virtual image according to the control signal from the control system so that two or more exit pupils are sequentially disposed.

5. The near-eye display device of claim 4, wherein the control system sequentially provides two or more parallax images to the display in synchronization with a change in aperture position of the dynamic aperture adjustment element to allow different parallax images to be disposed at positions of the exit pupils.

6. The near-eye display device of claim 1, further comprising a pupil tracking device configured to track an eye pupil position of the observer,
wherein the control system uses pupil tracking information acquired by the pupil tracking device to control the horizontal position of the aperture of the dynamic aperture adjustment element in real time such that the exit pupil is continuously disposed in the eye pupil of the observer.

7. The near-eye display device of claim 6, wherein the dynamic aperture adjustment element generates two or more aperture arrangements rearranged according to a moving direction of the eye pupil of the observer tracked by the pupil tracking device, one dynamic aperture at each horizontal position of the dynamic aperture adjustment element is operated within one frame virtual image according to the control signal from the control system, and the exit pupil is always placed within a pupil diameter according to the moving direction of the eye pupil of the observer to enlarge a size of the exit pupil in the moving direction of the eye pupil of the observer.

8. The near-eye display device of claim 6, wherein the dynamic aperture adjustment element generates two or more aperture arrangements rearranged according to a moving direction of the eye pupil of the observer tracked by the pupil tracking device, the apertures at the horizontal positions of the dynamic aperture adjustment element are sequentially operated within one frame virtual image according to the control signal from the control system, and two or more exit pupils are sequentially disposed according to the moving direction of the eye pupil of the observer to enlarge a size of the exit pupil in the moving direction of the eye pupil of the observer.

9. The near-eye display device of claim 7, wherein two or more aperture positions of the dynamic aperture adjustment element are arranged in a horizontal direction, a vertical direction, a diagonal direction, or a combination thereof on the plane perpendicular to the optical axis.

10. The near-eye display device of claim 1, wherein the control system adjusts the size of the aperture of the dynamic aperture element according to a set best virtual image position and the depth of focus range to adjust the size of the exit pupil at an eye pupil position such that a nearest image blur size of an image point formed on a retina at a nearest focus position of an eye is equal to a farthest image blur size of an image point formed on the retina at a farthest focus position of the eye, the nearest image blur size and the farthest image blur size are within ±20% of the same value as an image blur size due to diffraction, and a best position of an image point of a virtual image is an arithmetic mean position of a nearest focus position and a farthest focus position of the eye in a diopter unit.

11. The near-eye display device of claim 10, wherein the aperture of the dynamic aperture adjustment element is an annular aperture including a circular light blocking portion in a circular aperture.

12. The near-eye display device of claim 11, wherein, when a radius of the circular aperture is denoted by a and a radius of the circular light blocking portion is denoted by a₀, and when a ratio of the radius of the circular light blocking portion to the radius of the circular aperture is defined as β (≡a₀/a), β is zero or more and 1/3 or less.

13. The near-eye display device of claim 11, wherein, when a radius of the circular aperture is denoted by a and a radius of the circular light blocking portion is denoted by a₀, and when a ratio of the radius of the circular light blocking portion to the radius of the circular aperture is defined as β (≡a₀/a), β is zero or more and 0.45 or less.

14. The near-eye display device of claim 10, wherein the control system adjusts the size of the aperture of the dynamic aperture adjustment element to be wide so as to decrease the depth of focus range at a best virtual image position set according to a type of the virtual image and to provide an image with increased resolution.

15. The near-eye display device of claim 10, further comprising a display position adjustment element configured to adjust a distance between the display and the first lens,
wherein the control system controls the display position adjustment element according to the set best virtual image position to adjust a best virtual image position.

16. The near-eye display device of claim 10, wherein the first lens has a focal distance which is adjustable according to the control signal from the control system, and
the control system controls the focal distance of the first lens according to the set best virtual image position to adjust a best virtual image position.

17. The near-eye display device of claim 15, further comprising a pupil tracking device configured to track a focus adjustment position of the eye of the observer,
wherein the control system uses pupil tracking information acquired by the pupil tracking device to control the display position adjustment element to form a best virtual image position close to a focus adjustment position of the eye of the observer.

18. The near-eye display device of claim 16, further comprising a pupil tracking device configured to track a focus adjustment position of the eye of the observer,
wherein the control system uses pupil tracking information acquired by the pupil tracking device to control the focal distance of the first lens to form the best virtual image position close to a focus adjustment position of the eyeball of the observer.

19. The near-eye display device of claim 17, wherein two pupil tracking devices are provided and track convergence position information of both eyes of the observer, and the control system controls the display position adjustment element to form the best virtual image position close to a gaze convergence depth of the both eyes of the observer.

20. The near-eye display device of claim 18, wherein two pupil tracking devices are provided and track convergence position information of both eyes of the observer, and the control system controls the focal distance of the first lens to form the best virtual image position close to a gaze convergence depth of the both eyes of the observer.

21. The near-eye display device of claim 17, wherein, for an abnormal vision observer with nearsightedness or farsightedness, a vision correction value is input to the control system to correct a position of the display corresponding to the set best virtual image position so that the best virtual image position is provided to the abnormal vision observer without wearing vision correction glasses.

22. The near-eye display device of claim 18, wherein, for an abnormal vision observer with nearsightedness or farsightedness, a vision correction value is input to the control system to correct the focal distance of the first lens corresponding to the set best virtual image position so that the best virtual image position is provided to the abnormal vision observer without wearing vision correction glasses.

23. The near-eye display device of claim 15, wherein the display position adjustment element is a piezoelectric element configured to perform precise position control, a voice coil motor (VCM), or an LCD in which a refractive index thereof is changed according to an electrical signal to adjust an effective distance between the display and the first lens.

24. The near-eye display device of claim 16, wherein the first lens of which the focal distance is adjustable is a focus-tunable lens of which a precise focal distance is manually or electrically controllable, a polymer lens, a liquid lens, a liquid crystal lens, or a lens of which a refractive index is changed according to an electrical signal.

25. The near-eye display device of claim 1, wherein the display includes a plurality of pixels,
adjacent pixels of each pixel provide a first virtual image having first polarization and a second virtual image having second polarization which is orthogonal to the first polarization,
the dynamic aperture adjustment element includes a polarization aperture set including a first aperture having the first polarization and a second aperture having the second polarization, and
two virtual images of the display are transferred to an eye pupil position of the observer through the polarization aperture set of the dynamic aperture adjustment element so that the exit pupil is expanded.

26. The near-eye display device of claim 25, wherein the first virtual image and the second virtual image are parallax images.

27. The near-eye display device of claim 25, wherein the polarization aperture set of the dynamic aperture adjustment element has two or more horizontal positions, and
apertures at the horizontal positions of the dynamic aperture adjustment element are sequentially operated in one frame virtual image according to the control signal from the control system to allow two or more exit pupils to be sequentially disposed so that the size of the exit pupil is enlarged.

28. The near-eye display device of claim 27, wherein the control system sequentially provides two or more parallax images to the display in synchronization with a position change of the polarization aperture set of the dynamic aperture adjustment element so that different parallax images are disposed at positions of the exit pupils.

29. The near-eye display device of claim 6, further comprising two external sight cameras,
wherein an external image captured by the two external sight cameras is combined with a virtual image in the display through the control system and provided to each of both eyes of the observer.

30. The near-eye display device of claim 29, wherein information acquired by the pupil position tracking device is transmitted to the control system, and
the control system provides an image of the two external sight cameras to each of the both eyes of observer as a parallax image for each eyeball through a dynamic aperture.

31. The near-eye display device of claim 1, wherein a field of view is increased by enlarging an image of the display so as to be greater than a size of the display between the first lens and the main optics lens by using the first lens.

32. A near-eye display device comprising:
a display;
a first lens disposed in front of the display so as to be spaced apart from the display by a predetermined distance;
a dynamic aperture adjustment element disposed adjacent to the first lens to dynamically control an aperture size of the first lens and a horizontal position of an aperture thereof on a plane perpendicular to an optical axis;
the beam splitter disposed such that a virtual image providing direction and an external viewing window direction do not interfere with each other and configured to allow the virtual image and an external image to be simultaneously provided to an observer;
a trans-reflective concave mirror configured to reflect the virtual image to the observer and transmit the external image; and
a control system configured to control the dynamic aperture adjustment element,
wherein an eye pupil of the observer is positioned in an exit pupil disposed to be spaced apart from the trans-reflective concave mirror by a predetermined distance, and
a size and a horizontal position of the exit pupil are determined according to a size and the horizontal position of the aperture of the dynamic aperture adjustment element which are adjusted according to a control signal from the control system.

33. The near-eye display device of claim 32, further comprising a vision correction lens for an abnormal vision observer with nearsightedness or farsightedness provided on an outer surface of an external viewing window of the trans-reflective concave mirror.

34. The near-eye display device of claim 33, further comprising a display position adjustment element configured to adjust a distance between the display position and the first lens,
wherein the control system controls the display position adjustment element according to a set best virtual image position to adjust a best virtual image position.

35. The near-eye display device of claim 33, wherein the first lens has a focal distance which is adjustable according to the control signal from the control system, and
the control system controls the focal distance of the first lens according to a set best virtual image position to adjust a best virtual image position.

36. The near-eye display device of claim 34, further comprising a pupil tracking device configured to track an eye pupil position of the observer,
wherein the control system uses pupil tracking information acquired by the pupil tracking device to control the display position adjustment element to form the best virtual image position close to a focus adjustment position of an eye of the observer.

37. The near-eye display device of claim 35, further comprising a pupil tracking device configured to track an eye pupil position of the observer,
wherein the control system uses pupil tracking information acquired by the pupil tracking device to control the focal distance of the first lens to form the best virtual image position close to a focus adjustment position of an eye of the observer.

38. The near-eye display device of claim 36, wherein two pupil tracking devices are provided and track convergence position information of both eyes of the observer, and
the control system controls the display position adjustment element to form the best virtual image position close to a convergence position of the both eyes of the observer.

39. The near-eye display device of claim 37, wherein two pupil tracking devices are provided and track convergence position information of both eyes of the observer, and
the control system controls the focal distance of the first lens to form the best virtual image position close to a convergence position of the both eyes of the observer.

40. The near-eye display device of claim 36, wherein, for an abnormal vision observer with nearsightedness or farsightedness, a vision correction value is input to the control system to correct a position of the display corresponding to the set best virtual image position so that a best observing position is provided to the abnormal vision observer without wearing vision correction glasses.

41. The near-eye display device of claim 37, wherein, for an abnormal vision observer with nearsightedness or farsightedness, a vision correction value is input to the control system to correct the focal distance of the first lens corresponding to the set best virtual image position so that a best observing position is provided to the abnormal vision observer without wearing vision correction glasses.

42. The near-eye display device of claim 32, further comprising an external sight shielding component and two external sight cameras on an outer surface of an external viewing window of the trans-reflective concave mirror,
wherein an external image captured by the two external sight cameras is combined with the virtual image in the display through the control system and provided to each of both eyes of the observer.

43. The near-eye display device of claim 42, wherein the external sight shielding component is an optionally detachable clip type or an element of which transmittance is adjustable according to an electrical control signal.

44. The near-eye display device of claim 42, wherein the external image of the two external sight cameras is corrected in consideration of a corresponding eye pupil position of the observer and provided to each of the both eyes of the observer.

45. The near-eye display device of claim 1, wherein the near-eye display devices are disposed with respect to a left eye and a right eye, respectively, and each further include a mirror configured to change an optical path between the dynamic aperture adjustment element and the main optics lens.

46. The near-eye display device of claim 1, wherein the near-eye display devices are disposed with respect to a left eye and a right eye, respectively, and each further include a polarization beam splitter between the dynamic aperture adjustment element and the main optics lens and further include a half-wave retarder between the polarization beam splitters,
wherein, while light passing through a left side (or right side) dynamic aperture passes through the polarization beam splitter at a left side (or a right side) and the half-wave retarder, polarization direction thereof is converted, and the light is reflected by the polarization beam splitter at the right side (or the left side) and then travels to the main optics lens at a right side (or a left side).

47. The near-eye display device of claim 46, further comprising a mirror configured to change an optical path between the dynamic aperture adjustment element and the polarization beam splitter.

48. The near-eye display device of claim 32, further comprising a reflective mirror disposed to be spaced apart from the first lens by a predetermined distance and configured to reflect a virtual image to a beam splitter.
